(19) United States
(12) Patent Application Publication
(10) Pub. No.: US 2016/0027037 A1
(43) Pub. Date: Jan. 28, 2016

(54) EVENT GROUPING USING TIMEZONES

(71) Applicant: Google Inc., Mountain View, CA (US)

(72) Inventors: Congxing Cai, Los Angeles, CA (US); Iman Sadeghi, Los Angeles, CA (US); Farnaz Azmoodeh, Los Angeles, CA (US); Aaron Shon, Zurich (CH); Jonas Yngvesson, Engelberg (CH); Reto Strobl, Walenstadt (CH)

(21) Appl. No.: 14/470,653

(22) Filed: Aug. 27, 2014

Related U.S. Application Data
(60) Provisional application No. 62/027,629, filed on Jul. 22, 2014.

(51) Int. Cl. G06Q 30/02

(52) U.S. Cl. CPC G06Q 30/0243; G06Q 30/0246

(57) ABSTRACT

Systems, methods, and computer-readable storage media that may be used to attribute events such as clicks and conversions to impressions are provided. One method includes determining a local time and a timezone associated with each of a plurality of events of a content campaign. The method further includes generating a first event grouping including a first set of events having timezones matching at least one grouping timezones. The method further includes generating a second event grouping including a second set of the events based on both the local times and the timezones of the events. Generating the second event grouping includes selecting the second set of events based on the local times of the events in view of the timezones of the events. The method further includes, for each grouping, determining a number of events associated with frequency groups based on a number of impression events associated with the events.

### CROSS-REFERENCE TO RELATED APPLICATIONS

The present application claims the benefit of U.S. Provisional Patent Application No. 62/027,629, titled “Event Attribution,” filed on Jul. 22, 2014, the entirety of which is incorporated herein by reference.

### BACKGROUND

Content providers often publish content items in networked resources through online content management systems with the goal of having an end user interact with (e.g., click through) the content items and perform a converting action, such as providing information of value to the content providers and/or purchasing a product or service offered by the content providers. In some instances, content providers may wish to know how many users are being exposed to content items from their content campaigns and/or how many times users have been presented with content items. Some systems may calculate a reach for a campaign, or a number of unique users and/or devices to which impressions associated with the campaign have been presented. Some systems may additionally or alternatively determine frequency statistics for a campaign, or numbers of users presented with impressions from the campaign a certain number of times. However, such systems may contain only basic frequency-related information.

### SUMMARY

One illustrative implementation of the disclosure relates to a method that includes identifying, by one or more processors, a plurality of interaction events relating to one or more content campaigns. The method further includes identifying, by the one or more processors, a plurality of impression events relating to the one or more content campaigns. The impression events correspond to the provision of one or more content item impressions to one or more users. The method further includes, for each of the plurality of interaction events: (1) attributing, by the one or more processors, the interaction event to one or more of the impression events occurring prior to the interaction event; (2) determining, by the one or more processors, a number of impression events to which the interaction event is attributed; and (3) assigning, by the one or more processors, the interaction event to one of a plurality of frequency groups based on the number of impression events to which the interaction event is attributed. The method further includes, for each of the plurality of frequency groups, determining, by the one or more processors, a number of interaction events assigned to the frequency group.

Another implementation relates to a system including at least one computing device operably coupled to at least one memory. The at least one computing device is configured to identify a plurality of interaction events relating to one or more content campaigns. The at least one computing device is further configured to identify a plurality of impression events relating to the one or more content campaigns. The impression events correspond to the provision of one or more content item impressions to one or more users. The at least one computing device is further configured to, for each of the plurality of interaction events: (1) attribute the interaction event to one or more of the impression events occurring prior to the interaction event; (2) determine a number of impression events to which the interaction event is attributed; and (3) assign the interaction event to one of a plurality of frequency groups based on the number of impression events to which the interaction event is attributed. The at least one computing device is further configured to determine, for each of the plurality of frequency groups, a number of interaction events assigned to the frequency group.

Yet another implementation relates to one or more computer-readable storage media having instructions stored thereon that, when executed by at least one processor, cause the at least one processor to perform operations. The operations include identifying a plurality of interaction events relating to one or more content campaigns. The operations further include identifying a plurality of impression events relating to the one or more content campaigns. The impression events correspond to the provision of one or more content item impressions to one or more users. The operations further include: (1) attributing, by the one or more processors, the interaction event to one or more of the impression events occurring prior to the interaction event; (2) determining, by the one or more processors, a number of impression events to which the interaction event is attributed; and (3) assigning, by the one or more processors, the interaction event to one of a plurality of frequency groups based on the number of impressions events to which the interaction event is attributed. The operations further include, for each of the plurality of frequency groups, determining a number of interaction events assigned to the frequency group.

In some implementations, for each of the frequency groups, a number of users provided with impressions from the one or more content campaigns a number of times associated with the frequency group may be determined.

In some implementations, the plurality of interaction events comprises a plurality of click events corresponding to a selection by a user of a content item impression, and attributing the interaction event to the one or more impression events comprises, for each click event, attributing the click event to the one or more impression events occurring prior to the click event.

In some implementations, the plurality of interaction events comprises a plurality of conversion events, and attributing the interaction event to the one or more impression events comprises, for each conversion event: (1) determining the presence or absence of a click event associated with the conversion event, the click event corresponding to a selection by a user of a content item impression; (2) based on determining the absence of the click event, attributing the conversion event to a last impression event and a first set of zero or more prior impression events occurring before the last impression event; and (3) based on determining the presence of the click event, attributing the conversion event to the click event and a second set of one or more prior impression events occurring before the click event.

In some implementations, a timeframe for use in determining the number of interaction events assigned to each frequency group may be received, and the step of attributing the interaction event to the one or more impression events may include attributing the interaction event to a set of the one or more impression events having timestamp data indicating the associated content item impressions were provided to users within the timeframe.

In some implementations, a timeframe for use in determining the number of interaction events assigned to each frequency group may be received, identifying the plurality of interaction events comprises identifying a first set of the plurality of interaction events having timestamp data indicating the interaction events occurred within the timeframe, assigning the interaction event to one of a plurality of frequency groups comprises assigning each of the first set of interaction events to one of a plurality of frequency groups, and determining the number of interaction events assigned to each frequency group comprises determining, for each of the plurality of frequency groups, a number of interaction events in the first set of interaction events assigned to the frequency group.

In some implementations, attributing the interaction event to one or more of the impression events comprises attributing a first interaction event associated with a first content campaign to one or more first impression events associated with a second content campaign.

In some implementations, attributing the interaction event to one or more of the impression events comprises directly attributing the interaction event to a first impression event and indirectly attributing the interaction event to zero or more second impression events occurring prior to the first impression event.

Another implementation relates to a method including identifying, by one or more processors, an impression event relating to a content campaign. The impression event corresponds to the provision of a content item impression to a user. The method further includes identifying, by the one or more processors, a conversion event attributed to the impression event. The method further includes determining, by the one or more processors, a timing of the conversion event with respect to a predetermined period of time associated with the impression event. The method further includes generating, by the one or more processors, a first event data item representing the impression event. The method further includes representing, by the one or more processors, both the conversion event and the impression event within the first event data item responsive to the conversion event occurring prior to a lapse of the predetermined period of time. The method further includes, responsive to the conversion event occurring after the lapse of the predetermined period of time, generating, by the one or more processors, either: (1) a second event data item having an impression count equal to zero, such that a combination of the first event data item and the second event data item counts the impression event only once; or (2) a negating data item configured to cancel the impression count of the first event data item and a third event data item representing both the impression event and the conversion event. The method further includes, based in part on at least one of the first event data item, the second event data item, or the third event data item, determining a number of impression events to which the conversion event is attributed and assigning the conversion event to one of a plurality of frequency groups based on the determined number of impression events.

Yet another implementation relates to a system including at least one computing device operably coupled to at least one memory and configured to identify an impression event relating to a content campaign. The impression event corresponds to the provision of one or more content item impressions to one or more users. The at least one computing device is further configured to identify a conversion event attributed to the impression event. The at least one computing device is further configured to identify a second conversion event relating to the content campaign and occurring after the deadline. The at least one computing device is further configured to determine a timing of the conversion event with respect to a predetermined period of time associated with the impression event and generates a first event data item representing the impression event. The at least one computing device is further configured to represent both the conversion event and the impression event within the first event data item responsive to the conversion event occurring prior to a lapse of the predetermined period of time. The at least one computing device is further configured to, responsive to the conversion event occurring after the lapse of the predetermined period of time, generate either: (1) a second event data item having an impression count equal to zero, such that a combination of the first event data item and the second event data item counts the impression event only once; or (2) a negating data item configured to cancel the impression count of the first event data item and a third event data item representing both the impression event and the conversion event. The at least one computing device is further configured to, based in part on at least one of the first event data item, the second event data item, or the third event data item, determine a number of impression events to which the conversion event is attributed and assign the conversion event to one of a plurality of frequency groups based on the determined number of impression events.

Another implementation relates to one or more computer-readable storage media having instructions stored thereon that, when executed by at least one processor, cause the at least one processor to perform operations including identifying an impression event relating to a content campaign. The impression event corresponds to the provision of one or more content item impressions to one or more users. The operations further include identifying a conversion event attributed to the impression event. The operations further include determining a timing of the conversion event with respect to a predetermined period of time associated with the impression event and generating a first event data item representing the impression event. The operations further include representing both the conversion event and the impression event within the first event data item responsive to the conversion event occurring prior to a lapse of the predetermined period of time. The operations further include, responsive to the conversion event occurring after the lapse of the predetermined period of time, generating either: (1) a second event data item having an impression count equal to zero, such that a combination of the first event data item and the second event data item counts the impression event only once; or (2) a negating data item configured to cancel the impression count of the first event data item and a third event data item representing both the impression event and the conversion event. The operations further include, based in part on at least one of the first event data item, the second event data item, or the third event data item, determining a number of impression events to which the conversion event is attributed and assigning the conversion event to one of a plurality of frequency groups based on the determined number of impression events.

In some implementations, wherein the first event data item is defined as having a number of impressions greater than zero, and the second event data item may be generated having the impression count equal to zero.

In some implementations, the first event data item is defined as having a number of impressions greater than zero, and a negating data item configured to cancel the impression count of the first event data item and the third event data item representing both the impression event and the conversion event may be generated.

In some implementations, the step of representing the conversion event within the first event data item with the impression event comprising aggregating the conversion event with the impression event and any other impression events to which the conversion event is attributed that occur within the predetermined period of time.

In some implementations, for each of the frequency groups, a number of users provided with impressions from the content campaign a number of times associated with the frequency group may be determined.

In some implementations, the impression event is one of one or more impression events, and the conversion event may be attributed to the one or more impression events by: (1) determining the presence or absence of a click event associated with the conversion event, the click event corresponding to a selection by a user of a content item impression; (2) based on determining the absence of the click event, attributing the conversion event to the last attributed impression event and a first set of zero or more prior impression events occurring before the last attributed impression event; and (3) based on determining the presence of the click event, attributing the conversion event to the click event and a second set of one or more prior impression events occurring before the click event.

In some implementations, the conversion event is one of a plurality of conversion events, each of the plurality of conversion events may be assigned to one of the plurality of frequency groups based on a number of impression events attributed to the conversion event, and, for each of the plurality of frequency groups, a number of conversion events assigned to the frequency group may be determined.

Another implementation relates to a method including determining, by one or more processors, a conversion event for a campaign grouping including a plurality of content campaigns. Each of the plurality of content campaigns includes one or more content items and has an associated campaign identifier, and the conversion event is associated with a first campaign identifier. The method further includes determining, by the one or more processors, a plurality of impression events occurring prior to the conversion event and associated with one of the plurality of content campaigns. The impression events correspond to the provision of one or more content item impressions to one or more users. The method further includes attributing, by the one or more processors, the conversion event to one or more of the plurality of impression events. At least one of the one or more impression events is associated with a second campaign identifier. The method further includes determining, by the one or more processors, a number of impression events to which the conversion event is attributed and assigning, by the one or more processors, the conversion event to one of a plurality of frequency groups based on the number of impression events to which the conversion event is attributed.

Yet another implementation relates to a system including at least one computing device operably coupled to at least one memory and configured to determine a conversion event for a campaign grouping including a plurality of content campaigns. Each of the plurality of content campaigns includes one or more content items and has an associated campaign identifier, and the conversion event is associated with a first campaign identifier. The at least one computing device is further configured to determine a plurality of impression events occurring prior to the conversion event and associated with one of the plurality of content campaigns. The impression events correspond to the provision of one or more content item impressions to one or more users. The at least one computing device is further configured to attribute the conversion event to one or more of the plurality of impression events. At least one of the one or more impression events is associated with a second campaign identifier. The at least one computing device is further configured to determine a number of impression events to which the conversion event is attributed and assign the conversion event to one of a plurality of frequency groups based on the number of impressions events to which the conversion event is attributed.

Another implementation relates to one or more computer-readable storage media having instructions stored thereon that, when executed by at least one processor, cause the at least one processor to perform operations including determining a conversion event for a campaign grouping including a plurality of content campaigns. Each of the plurality of content campaigns includes one or more content items and has an associated campaign identifier, and the conversion event is associated with a first campaign identifier. The operations further include determining a plurality of impression events occurring prior to the conversion event and associated with one of the plurality of content campaigns. The impression events correspond to the provision of one or more content item impressions to one or more users. The operations further include attributing the conversion event to one or more of the plurality of impression events. At least one of the one or more impression events is associated with a second campaign identifier. The operations further include determining a number of impression events to which the conversion event is attributed and assigning the conversion event to one of a plurality of frequency groups based on the number of impressions events to which the conversion event is attributed.

In some implementations, the conversion event is one of a plurality of conversion events, each of the plurality of conversion events is assigned to one of the plurality of frequency groups based on a number of impression events to which the conversion event is attributed, and, for each of the plurality of frequency groups, a number of conversion events assigned to the frequency group is determined.

In some implementations, for each of the plurality of frequency groups, a number of users provided with impressions from the campaign grouping a number of times associated with the frequency group is determined.

In some implementations, for each of the plurality of frequency groups, a number of selections of content items by users provided with impressions from the campaign grouping a number of times associated with the frequency group is determined.

In some implementations, the step of attributing the conversion event to the one or more impression events includes: (1) determining the presence or absence of a click event associated with one of the plurality of campaigns occurred prior to the conversion event, the click event corresponding to a selection by one or more users of one or more of the content item impressions; (2) based on determining the absence of the click event, attributing the conversion event to a last impression event and a first set of zero or more prior impression events occurring before the last impression event; and (3) based on determining the presence of the click event, attributing the conversion event to the click event and a second set of one or more prior impression events occurring before the click event.

In some implementations, a first campaign of the plurality of content campaigns is associated with a first medium, and a second campaign of the plurality of content campaigns is associated with a second medium. In some such implementations, the first campaign is associated with one or more search content items to be displayed with a search results interface, and the second campaign is associated with one or more video content items to be displayed within a video interface.

In some implementations, a selection of the plurality of content campaigns to include in the campaign grouping is received from a content provider.

In some implementations, it is determined whether the conversion is a duplicate of another conversion based on a timestamp associated with the conversion and the other conversion.

Another implementation relates to a method including determining, by one or more processors, a plurality of campaign groupings, each including two or more content campaigns. Each of the content campaigns includes one or more content items. The method further includes separating, by the one or more processors, the plurality of campaign groupings into: (1) a first set of one or more campaign groupings including previously defined campaign groupings having valid reach and frequency data defining, for each of a plurality of frequency groups, a number of users presented with a number of impressions associated with the frequency group and a number of events attributed to the number of impressions associated with the frequency group; and (2) a second set of one or more campaign groupings comprising new or modified campaign groupings for which the valid reach and frequency data does not exist. The method further includes, for each campaign grouping in the first set of campaign groupings, determining one or more impression events to which to attribute each of one or more interaction events based on the valid reach and frequency data and an updated data item reflecting events occurring during a current reporting period. The method further includes, for each campaign grouping in the second set of campaign groupings, determining one or more impression events from which to attribute each interaction event by performing a backfill operation including: (1) retrieving event data items for each of the content campaigns in the campaign grouping for a predetermined historical timeframe; (2) for each interaction event, determining, based on the event data items, the one or more impression events to which to attribute the interaction event; and (3) generating updated event data items reflecting the attributions. The method further includes, for each of the plurality of campaign groupings: (1) determining, by the one or more processors, a number of impression events to which each interaction event is attributed; and (2) assigning, by the one or more processors, each interaction event to one of the frequency groups based on the number of impressions events to which the interaction event is attributed.

Yet another implementation relates to a system including at least one computing device operably coupled to at least one memory and configured to determine a plurality of campaign groupings each including two or more content campaigns. Each of the content campaigns includes one or more content items. The at least one computing device is further configured to separate the plurality of campaign groupings into: (1) a first set of one or more campaign groupings including previously defined campaign groupings having valid reach and frequency data defining, for each of a plurality of frequency groups, a number of users presented with a number of impressions associated with the frequency group and a number of events attributed to the number of impressions associated with the frequency group; and (2) a second set of one or more campaign groupings comprising new or modified campaign groupings for which the valid reach and frequency data does not exist. The at least one computing device is further configured to, for each campaign grouping in the first set of campaign groupings, determine one or more impression events to which to attribute each of one or more interaction events based on the valid reach and frequency data and an updated data item reflecting events occurring during a current reporting period. The at least one computing device is further configured to, for each campaign grouping in the second set of campaign groupings, determine one or more impression events to which to attribute each interaction event by performing a backfill operation including: (1) retrieving event data items for each of the content campaigns in the campaign grouping for a predetermined historical timeframe; (2) for each interaction event, determining, based on the event data items, the one or more impression events to which to attribute the interaction event; and (3) generating updated event data items reflecting the attributions. The at least one computing device is further configured to, for each of the plurality of campaign groupings: (1) determine a number of impression events to which each interaction event is attributed; and (2) assign each interaction event to one of the frequency groups based on the number of impressions events to which the interaction event is attributed.

Another implementation relates to one or more computer-readable storage media having instructions stored thereon that, when executed by at least one processor, cause the at least one processor to perform operations including determining a plurality of campaign groupings each including two or more content campaigns. Each of the content campaigns includes one or more content items. The operations further include separating the plurality of campaign groupings into: (1) a first set of one or more campaign groupings including previously defined campaign groupings having valid reach and frequency data defining, for each of a plurality of frequency groups, a number of users presented with a number of impressions associated with the frequency group and a number of events attributed to the number of impressions associated with the frequency group; and (2) a second set of one or more campaign groupings comprising new or modified campaign groupings for which the valid reach and frequency data does not exist. The operations further include, for each campaign grouping in the first set of campaign groupings, determining one or more impression events to which to attribute each of one or more interaction events based on the valid reach and frequency data and an updated data item reflecting events occurring during a current reporting period. The operations further include, for each campaign grouping in the second set of campaign groupings, determining one or more impression events to which to attribute each interaction event by performing a backfill operation including: (1) retrieving event data items for each of the content campaigns in the campaign grouping for a predetermined historical timeframe; (2) for each interaction event, determining, based on the event data items, the one or more impression events to which to attribute the interaction event; and (3) generating updated event data items reflecting the attributions. The operations further include, for each of the plurality of campaign groupings: (1) determining a number of impression events to which each interaction event is attributed; and (2) assigning each interaction event to one of the frequency groups based on the number of impression events to which the interaction event is attributed.

In some implementations, the interaction event is one of a plurality of interaction events, and, for each of the plurality of campaign groupings: (1) each of the plurality of interaction events is assigned to one of the plurality of frequency groups based on a number of impression events to which the interaction event is attributed; and (2) for each of the plurality of frequency groups, a number of interaction events assigned to the frequency group is determined.

In some implementations, for each campaign grouping, an overlap in impressions provided to same users in two or more of the content campaigns for the campaign grouping is determined.

In some implementations, a modification to a first campaign grouping of the plurality of campaign groupings is received, it is determined whether the first campaign grouping is awaiting completion of a current backfill operation, the current backfill operation is discarded when the first campaign grouping is awaiting completion of a current backfill operation, and a new backfill operation for the modified first campaign grouping is conducted.

In some implementations, attributing the interaction event to the one or more impression events includes: (1) determining the presence or absence of a click event associated with one of the plurality of campaigns occurring prior to a conversion event, the click event corresponding to a selection by one or more users of one or more of the content item impressions; (2) based on determining the absence of the click event, attributing the conversion event to a last impression event and a first set of zero or more prior impression events occurring before the last impression event; and (3) based on determining the presence of the click event, attributing the conversion event to the click event and a second set of one or more prior impression events occurring before the click event.

In some implementation, a first campaign is associated with a first medium, and a second campaign is associated with a second medium. In some such implementation, the first campaign is associated with one or more search content items to be displayed with a search results interface, and the second campaign is associated with one or more video content items to be displayed within a video interface. In some such implementations, it may be determined whether an interaction event associated with the first medium is a duplicate of an interaction event associated with the second medium.

In some implementations, a selection of the content campaigns to include in the campaign grouping may be received from a content provider.

Another implementation relates to a method including receiving, by one or more processors, a request to generate a first report relating to a content campaign based on first criteria and a second report relating to the content campaign based on second criteria. The content campaign includes a plurality of content items to be provided to a plurality of users. The first criteria include one or more grouping timezones. The method further includes retrieving, by one or more processors, a plurality of events for the content campaign and determining, by the one or more processors, a local time and a timezone associated with each of the plurality of events. The method further includes, based on the first criteria including the one or more grouping timezones, generating, by the one or more processors, a first event grouping including a first set of the plurality of events having timezones matching at least one of the one or more grouping timezones. The method further includes, based on the second criteria, generating, by the one or more processors, a second event grouping including a second set of the plurality of events based on both the local times and the timezones of the plurality of events. Generating the second event grouping includes selecting the second set of events from among the plurality of events based on the local times of the events in view of the timezones of the events. The method further includes, for each of the first event grouping and the second event grouping, determining, by the one or more processors, a number of events associated with each of a plurality of frequency groups based on a number of impression events associated with the events. The method further includes generating, by the one or more processors, the first report based on the determined number of events for the first event grouping and the second report based on the determined number of events for the second event grouping.

Yet another implementation relates to a system including at least one computing device operably coupled to at least one memory and configured to receive a request to generate a first report relating to a content campaign based on first criteria and a second report relating to the content campaign based on second criteria. The content campaign includes a plurality of content items to be provided to a plurality of users. The first criteria include one or more grouping timezones. The at least one computing device is further configured to retrieve a plurality of events for the content campaign and determine a local time and a timezone associated with each of the plurality of events. The at least one computing device is further configured to, based on the first criteria including the one or more grouping timezones, generate a first event grouping including a first set of the plurality of events having timezones matching at least one of the one or more grouping timezones. The at least one computing device is further configured to, based on the second criteria, a second event grouping including a second set of the plurality of events based on both the local times and the timezones of the plurality of events by selecting the second set of events from among the plurality of events based on the local times of the events in view of the timezones of the events. The at least one computing device is further configured to, for each of the first event grouping and the second event grouping, determine a number of events associated with each of a plurality of frequency groups based on a number of impression events associated with the events. The at least one computing device is further configured to generate the first report based on the determined number of events for the first event grouping and the second report based on the determined number of events for the second event grouping.

Another implementation relates to one or more computer-readable storage media having instructions stored thereon that, when executed by at least one processor, cause the at least one processor to perform operations including receiving a request to generate a first report relating to a content campaign based on first criteria and a second report relating to the content campaign based on second criteria. The content campaign includes a plurality of content items to be provided to a plurality of users. The first criteria include one or more grouping timezones. The operations further include retrieving a plurality of events for the content campaign and determining a local time and a timezone associated with each of the plurality of events. The operations further include, based on the first criteria including the one or more grouping timezones, generating a first event grouping including a first set of the plurality of events having timezones matching at least one of the one or more grouping timezones. The operations further include, based on the second criteria, generating a second event grouping including a second set of the plurality of events based on both the local times and the timezones of the plurality of events. Generating the second event grouping includes selecting the second set of events from among the plurality of events based on the local times of the events in view of the timezones of the events. The operations further include, for each of the first event grouping and the second event grouping, determining a number of events associated with each of a plurality of frequency groups based on a number of impression events associated with the events. The operations further include generating the first report based on the determined number of events for the first event grouping and the second report based on the determined number of events for the second event grouping.

In some implementations, the first event grouping is based on a first grouping timezone, and the second event grouping is based on a second grouping time range without a timezone.

In some implementations, the step of generating the first event grouping comprising generating the first event grouping based on one or more first characteristics of the first set of events, and the step of generating the second event grouping comprising generating the second event grouping based on one or more second characteristics of the second set of events.

In some implementations, each of the plurality of events is associated with one of a first content medium or a second content medium. In some such implementations, the step of determining the number of events associated with each of the plurality of frequency groups comprising counting events associated with both the first content medium and the second content medium within the determined number of events.

In some implementations, each of the plurality of events comprises one of a click event or a conversion event.

In some implementations, a selection of one or more parameters for use in determining at least one of the first event grouping or the second event grouping may be received from a content provider.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of an analysis system and associated environment according to an illustrative implementation.

FIG. 2 is a more detailed block diagram of an analysis system according to an illustrative implementation.

FIG. 3 is an illustration of click and conversion attribution according to an illustrative implementation.

FIG. 4 is another illustration of click and conversion attribution including frequency values according to an illustrative implementation.

FIG. 5 is a flow diagram of a process for attributing interaction events to impression events and assigning events to frequency groups according to an illustrative implementation.

FIG. 6 is a flow diagram of a process for attributing a conversion event to click and/or impression events according to an illustrative implementation.

FIG. 7 is an illustration of click and conversion attribution with different time ranges according to an illustrative implementation.

FIG. 8 is a table illustrating frequency groups to which impressions, clicks, and conversions shown in FIG. 7 are attributed under a first time range according to an illustrative implementation.

FIG. 9 is a table illustrating frequency groups to which impressions, clicks, and conversions shown in FIG. 7 are attributed under a second time range according to an illustrative implementation.

FIG. 10 is an illustration of click and conversion attribution with different sites according to an illustrative implementation.

FIG. 11 is a table illustrating frequency groups to which impressions, clicks, and conversions shown in FIG. 10 are attributed under both sites according to an illustrative implementation.

FIG. 12 is a table illustrating frequency groups to which impressions, clicks, and conversions shown in FIG. 10 are attributed under a first site according to an illustrative implementation.

FIG. 13 is a table illustrating frequency groups to which impressions, clicks, and conversions shown in FIG. 10 are attributed under a second site according to an illustrative implementation.

FIG. 14 is an illustration of click and conversion attribution and aggregated logs reflecting the attribution according to an illustrative implementation.

FIG. 15 is a block diagram of log processing reach and frequency portions of an analysis system according to an illustrative implementation.

FIG. 16 is another block diagram of a reach and frequency portion of an analysis system according to an illustrative implementation.

FIG. 17 illustrates example data including a list of dates upon which impressions are displayed and a table totaling the number of impressions per day according to an illustrative implementation.

FIG. 18 is a table corresponding to the data shown in FIG. 17 showing a count of identifiers on day X whose last impression was exactly Y days ago according to an illustrative implementation.

FIG. 19 is a table corresponding to the data shown in FIG. 17 showing a count of identifiers on day X whose second to last impression was exactly Y days ago according to an illustrative implementation.

FIG. 20 is a data flow diagram illustrating a process for determining a reach for different frequency groups according to an illustrative implementation.

FIG. 21 is a table corresponding to example click data showing a count of clicks/conversions on day X whose last impression was exactly Y days ago according to an illustrative implementation.

FIG. 22 is a table corresponding to example click data showing a count of clicks/conversions on day X whose second to last impression was exactly Y days ago according to an illustrative implementation.

FIG. 23 is a table corresponding to example click data showing a count of clicks/conversions on day X whose third to last impression was exactly Y days ago according to an illustrative implementation.

FIG. 24 is a data flow diagram illustrating a process for determining a number of interaction (e.g., click/conversion) events for different frequency groups according to an illustrative implementation.

FIG. 25 is a user interface displaying data for each of several frequency groups according to an illustrative implementation.

FIG. 26 is a flow diagram of a process for attributing conversion events to impression events and assigning the conversion events to frequency groups when one or more of the conversion events occur after a deadline according to an illustrative implementation.

FIG. 27 is a flow diagram of a process for attributing interaction events (e.g., conversion events) to impression events across a campaign grouping including multiple campaigns according to an illustrative implementation.

FIG. 28 is an illustration of conversion attribution for multiple campaign groupings according to an illustrative implementation.

FIG. 29 is another illustration of conversion attribution for multiple campaign groupings according to an illustrative implementation.

FIG. 30 is a flow diagram of a process for attributing interaction events to impression events for different campaign groupings using a backfill operation according to an illustrative implementation.

FIG. 31 is a block diagram of a backend pipeline for processing attribution for campaign groupings according to an illustrative implementation.

FIG. 32 is a state diagram for processing campaign grouping modifications, additions, and activations according to an illustrative implementation.

FIG. 33 is a first block diagram for processing attribution and frequency grouping across multiple campaigns/media according to an illustrative implementation.

FIG. 34 is a second block diagram for processing attribution and frequency grouping across multiple campaigns/media according to an illustrative implementation.

FIG. 35 is a third block diagram for processing attribution and frequency grouping across multiple campaigns/media according to an illustrative implementation.

FIG. 36 is an illustration of a user interface for providing incremental reach and frequency information according to an illustrative implementation.

FIG. 37 is an illustration of a user interface for providing cross-media de-duplicated reach information according to an illustrative implementation.

FIG. 38 is a flow diagram of a process for generating reports for event (e.g., campaign/media) groupings based on a local time and/or timezone according to an illustrative implementation.

FIG. 39 is a block diagram of a computing device according to an illustrative implementation.

### DETAILED DESCRIPTION

Referring generally to the Figures, various illustrative systems and methods are provided that may be used to correctly attribute clicks and/or conversions to impressions and determine campaign statistics on a frequency group basis. Analysis systems may be designed to determine reach and frequency statistics for campaigns. In some such implementations, a system may determine a reach for the campaign, or a number of unique users and/or devices to which impressions associated with the campaign have been presented. The system may additionally or alternatively determine frequency statistics associated with the campaign. For instance, the system may determine a number of users who have been presented with exactly three impressions, exactly four impressions, at least five impressions, etc. Such statistics may give a content provider an idea of the impact of the campaign, which may help the content provider gauge whether the campaign is successful or should be adjusted. However, such systems may not be configured to determine campaign statistics such as clicks and/or conversions at a frequency group level.

According to various illustrative implementations, the systems and methods of the present disclosure may attribute interaction events, such as clicks and/or conversions, to one or more impression events, and may determine statistics for the interaction events for different frequency groups. An analysis system may determine one or more interaction events, such as conversion events (e.g., purchases of products/services, submission of requested information by users, etc.) and/or click events (e.g., selections of content item impressions), for a campaign. The system may also determine impressions of content items from the campaign presented to users.

The system may attribute each interaction event to one or more of the impression events occurring prior to the interaction event. Attribution, in this context, may include a direct attribution of an interaction event to a first impression event occurring prior to the interaction event, as well as indirect attribution of the interaction event to zero or more associated impression events occurring prior to the first impression event to which the interaction event is directly attributed. In some implementations, a click may be attributed to one or more impressions presented to the user prior to the click (e.g., directly attributed to an impression occurring prior the click, and indicrectly attributed to zero or more impressions occurring prior to that impression). In some illustrative implementations, a conversion (e.g., a view-through conversion, or VTC) may be attributed to one or more impressions, and may be assigned to a frequency group based on a number of impressions from the campaign grouping provided to the user prior to the conversion. In some implementations, a conversion (e.g., a click-through conversion, or CTC) may be attributed to a click, or selection, occurring prior to the conversion, as well as one or more impressions provided to the user prior to the click. The CTC may be assigned to a frequency group based on the number of impressions provided prior to the click. In some implementations, the system may classify the conversion as a CTC when a click occurs prior to the conversion and as a VTC when a click does not occur prior to the conversion. In some implementations, the system may assign the interaction events to frequency groups based on a number of impressions attributed to the interaction events.

The system may determine, for each of the frequency groups, a number of interaction events assigned to the frequency group. For instance, the system may determine a number of VTCs associated with users who were presented with exactly one impression, exactly two impressions, at least three impressions, etc. prior to conversion. In some implementations, the system may also determine a number of users provided with the number of impressions associated with the frequency group, a conversion rate for the frequency group, and/or other types of data for the campaign on a frequency group level.

In some implementations, the system may receive a timeframe for use in determining the interaction events for the frequency groups. For instance, the system may allow a user to specify an arbitrary date range. In some implementations, the system may attribute the interaction events to only impressions falling within the specified timeframe. In some implementations, the system may only count interaction events occurring within the specified timeframe when determining the number of interaction events assigned to each frequency group.

In some implementations, the system may be configured to generate different data items to handle events occurring before and after a deadline. Events occurring before a deadline (e.g., within a same timeframe, such as a 24 hour period, as one or more impression events to which the event is attributed) may be represented within a same data item as the impression event(s). Events occurring after the deadline may be represented using a separate data item. This may allow the system to handle late-occurring events without making substantial changes to the normal data item structure for events occurring before the deadline.

In some implementations, the system may be configured to attribute interaction events to impression events in a campaign grouping including multiple campaigns. In one illustrative implementation, a conversion associated with a first campaign may follow the presentation of two impressions associated with the first campaign and two impressions associated with a second campaign in a grouping. In such an implementation, if the system analyzed the campaigns separately, the system might determine that the user was presented with two impressions prior to the conversion. In one illustrative implementation, the system may determine, in the context of the campaign grouping, that the user was presented with four impressions prior to conversion. Even though two of the impressions were from a different campaign than the campaign associated with the conversion, the campaigns are grouped for the purposes of the analysis. The system may attribute the conversion in part to the two impressions from the other campaign as well as the impressions from the campaign associated with the conversion. In some illustrative implementations, a conversion may be attributed to a last click prior to conversion, as well as one or more impressions and/or clicks occurring prior to the last click. In some implementations, the campaign grouping may include campaigns based in different media, such as a video-based campaign for presenting video content items within a video interface and a search-based campaign for presenting content items within a search results interface of a search engine.

In some implementations, the system may be configured to process data relating to multiple campaign groupings for use in attributing the interaction events to impressions based on a status of the campaign groupings. If a grouping was previously defined and activated and has already had previous reach and frequency data prepared, the system may utilize that previously prepared reach and frequency data to determine attribution for new events. For instance, the system may update the previously existing data with a set of new data, rather than discarding the original data. This may be done periodically, such as on a daily basis. If a grouping has been modified, is new, or has been activated from an inactive state, the system may perform a backfill operation to analyze historical data for a particular period of time (e.g., last 90 days) and correctly attribute events. Thus, in some implementations, separate processing pipelines may be used for active, previously defined groupings that are being updated, new, modified, and/or reactivated groupings that are processed from scratch to ensure correct attribution of interaction events to impression events.

In some implementations, the system may attribute events and/or generate reach and frequency data for different event groupings. The system may generate different event groupings. For some of the groupings, the system may utilize both a local time and a timezone when generating the grouping. For other groupings, the system may utilize only one of the local time and the timezone. The system may determine a number of events associated with each of the frequency groups for each of the event groupings.

For situations in which the systems discussed herein collect and/or utilize personal information about users, or may make use of personal information, the users may be provided with an opportunity to control whether programs or features that may collect personal information (e.g., information about a user's social network, social actions or activities, a user's preferences, a user's current location, etc.), or to control whether and/or how to receive content from the content server that may be more relevant to the user. In addition, certain data may be anonymized in one or more ways before it is stored or used, so that personally identifiable information is removed when generating parameters (e.g., demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server. Further, the individual user information itself is not surfaced to the content provider, so the content provider cannot discern the interactions associated with particular users.

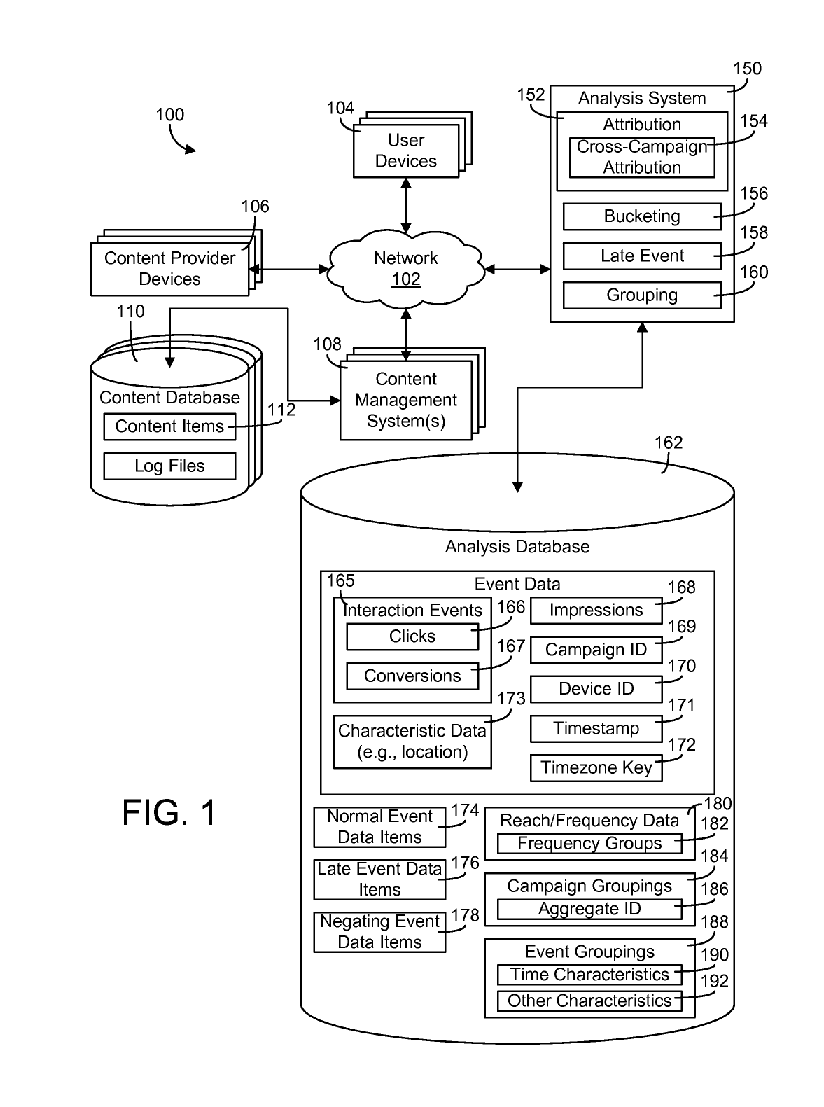

Referring now to FIG. 1, and in a brief overview, a block diagram of an analysis system 150 and associated environment 100 is shown according to an illustrative implementation. One or more user devices 104 may be used by a user to perform various actions and/or access various types of content, some of which may be provided over a network 102 (e.g., the Internet, LAN, WAN, etc.). For example, user devices 104 may be used to access websites (e.g., using an internet browser), media files, and/or any other types of content. One or more content management systems 108 may be configured to select content for display to users within resources (e.g., webpages, applications, etc.) and to provide content items 112 from a content database 110 to user devices 104 over network 102 for display within the resources. The content from which content management system 108 selects items may be provided by one or more content providers via network 102 using one or more content provider devices 106.

In some implementations, bids for content to be selected by content management system 108 may be provided to content management system 108 from content providers participating in an auction using devices, such as content provider devices 106, configured to communicate with content management system 108 through network 102. In such implementations, content management system 108 may determine content impressions to be published in one or more content interfaces of resources (e.g., webpages, applications, etc.) shown on user devices 104 based at least in part on the bids. Users may subsequently interact with the content item impressions and/or perform actions after interacting with the impressions, such as clicking through the impressions and/or performing a conversion action (e.g., purchase a product/service, provide requested data to a content provider, etc.) after viewing and/or clicking through an impression. Data reflecting the impressions and/or the interactions after the impressions may be stored in log files.

An analysis system 150 may be configured to analyze event data 164 relating to interaction events 165, such as clicks 166 and/or conversions 167, and attribute interaction events 165 to one or more impressions 168. System 150 may attribute each of interaction events 165 to one or impressions 168 based on, for example, the interaction events 165 and impressions 168 being associated with a common campaign identifier 169 and a timestamp 171 indicating that the impressions 168 were provided before the interaction events 165. System 150 may determine a number of impressions 168 attributed to each interaction event 165, and assign each interaction event 165 to one of several frequency groups 182 based on the determined number. For instance, one frequency group 182 may include interaction events occurring after one impression, another frequency group 182 may include interaction events occurring after two impressions, and so on. System 150 may determine a number of interaction events 165 assigned to each frequency group 182. In some implementations, this data may be provided to a content provider, and the content provider may use the data to make decisions about a target number of impressions to display to users/devices. For instance, if the data illustrates a high number or percentage of conversions 167 corresponding to a frequency of four impressions 168, the content provider may modify its campaign with the goal of reaching each user/device four times.

Referring still to FIG. 1, and in greater detail, user devices 104 and/or content provider devices 106 may be any type of computing device (e.g., having a processor and memory or other type of computer-readable storage medium), such as a television and/or set-top box, mobile communication device (e.g., cellular telephone, smartphone, etc.), computer and/or media device (desktop computer, laptop or notebook computer, netbook computer, tablet device, gaming system, etc.), or any other type of computing device. In some implementations, one or more user devices 104 may be set-top boxes or other devices for use with a television set. In some implementations, content may be provided via a web-based application and/or an application resident on a user device 104. In some implementations, user devices 104 and/or content provider devices 106 may be designed to use various types of software and/or operating systems. In various illustrative implementations, user devices 104 and/or content provider devices 106 may be equipped with and/or associated with one or more user input devices (e.g., keyboard, mouse, remote control, touchscreen, etc.) and/or one or more display devices (e.g., television, monitor, CRT, plasma, LCD, LED, touchscreen, etc.).

User devices 104 and/or content provider devices 106 may be configured to receive data from various sources using a network 102. In some implementations, network 102 may comprise a computing network (e.g., LAN, WAN, Internet, etc.) to which user devices 104 and/or content provider device 106 may be connected via any type of network connection (e.g., wired, such as Ethernet, phone line, power line, etc., or wireless, such as WiFi, WiMAX, 3G, 4G, satellite, etc.). In some implementations, network 102 may include a media distribution network, such as cable (e.g., coaxial metal cable), satellite, fiber optic, etc., configured to distribute media programming and/or data content.

A content management system 108 may be configured to conduct a content auction among third-party content providers to determine which third-party content is to be provided to a user device 104. For example, content management system 108 may conduct a real-time content auction in response to a user device 104 requesting first-party content from a content source (e.g., a website, search engine provider, etc.) or executing a first-party application. Content management system 108 may use any number of factors to determine the winner of the auction. For example, the winner of a content auction may be based in part on the third-party content provider's bid and/or a quality score for the third-party provider's content (e.g., a measure of how likely the user of the user device 104 is to click on the content). In other words, the highest bidder is not necessarily the winner of a content auction conducted by content management system 108, in some implementations.

Content management system 108 may be configured to allow third-party content providers to create campaigns to control how and when the provider participates in content auctions. A campaign may include any number of bid-related parameters, such as a minimum bid amount, a maximum bid amount, a target bid amount, or one or more budget amounts (e.g., a daily budget, a weekly budget, a total budget, etc.). In some cases, a bid amount may correspond to the amount the third-party provider is willing to pay in exchange for their content being presented at user devices 104. In some implementations, the bid amount may be on a cost per impression or cost per thousand impressions (CPM) basis. In further implementations, a bid amount may correspond to a specified action being performed in response to the third-party content being presented at a user device 104. For example, a bid amount may be a monetary amount that the third-party content provider is willing to pay, should their content be clicked on at the client device, thereby redirecting the client device to the provider's webpage or another resource associated with the content provider. In other words, a bid amount may be a cost per click (CPC) bid amount. In another example, the bid amount may correspond to an action being performed on the third-party provider's website, such as the user of the user device 104 making a purchase. Such bids are typically referred to as being on a cost per acquisition (CPA) or cost per conversion basis.

A campaign created via content management system 108 may also include selection parameters that control when a bid is placed on behalf of a third-party content provider in a content auction. If the third-party content is to be presented in conjunction with search results from a search engine, for example, the selection parameters may include one or more sets of search keywords. For instance, the third-party content provider may only participate in content auctions in which a search query for “golf resorts in California” is sent to a search engine. Other illustrative parameters that control when a bid is placed on behalf of a third-party content provider may include, but are not limited to, a topic identified using a device identifier's history data (e.g., based on webpages visited by the device identifier), the topic of a webpage or other first-party content with which the third-party content is to be presented, a geographic location of the client device that will be presenting the content, or a geographic location specified as part of a search query. In some cases, a selection parameter may designate a specific webpage, website, or group of websites with which the third-party content is to be presented. For example, an advertiser selling golf equipment may specify that they wish to place an advertisement on the sports page of an particular online newspaper.

Content management system 108 may also be configured to suggest a bid amount to a third-party content provider when a campaign is created or modified. In some implementations, the suggested bid amount may be based on aggregate bid amounts from the third-party content provider's peers (e.g., other third-party content providers that use the same or similar selection parameters as part of their campaigns). For example, a third-party content provider that wishes to place an advertisement on the sports page of an online newspaper may be shown an average bid amount used by other advertisers on the same page. The suggested bid amount may facilitate the creation of bid amounts across different types of client devices, in some cases. In some implementations, the suggested bid amount may be sent to a third-party content provider as a suggested bid adjustment value. Such an adjustment value may be a suggested modification to an existing bid amount for one type of device, to enter a bid amount for another type of device as part of the same campaign. For example, content management system 108 may suggest that a third-party content provider increase or decrease their bid amount for desktop devices by a certain percentage, to create a bid amount for mobile devices.

In some implementations, environment 100 may include multiple content management systems 108. For example, a first content management system 108 may be configured to select content items for presentation via a first medium, such as search-based medium (e.g., a search results interface presented by a search engine). A second content management system 108 may be configured to select content items for presentation via a second medium, such as a video-based medium (e.g., video-based content items embedded within content from a video service). In various implementations, content management systems 108 may be configured to select content items to present over a variety of different media, such as search-based media, video-based media, audio-based media, location-based media (e.g., a mapping service), application-based media (e.g., interfaces embedded within application resources), display-based media (e.g., interfaces embedded within resources such as webpages), etc.

Analysis system 150 may be configured to analyze event data 164 relating to user interactions via user devices 104 with content items from one or more content campaigns, and attribute interaction events 165, such as clicks 166 and/or conversions 167 to impressions 168. Based on the attribution, analysis system 150 may assign interaction events 165 to frequency groups 182 based on a number of impressions 168 attributed to the interaction events 165. Analysis system 150 may include one or more processors (e.g., any general purpose or special purpose processor), and may include and/or be operably coupled to one or more memories (e.g., any computer-readable storage media, such as a magnetic storage, optical storage, flash storage, RAM, etc.). In various implementations, analysis system 150 and a content management system 108 may be implemented as separate systems or integrated within a single system (e.g., a content management system 108 may be configured to incorporate some or all of the functions/capabilities of analysis system 150).

Analysis system 150 may include one or more modules (e.g., implemented as computer-readable instructions executable by a processor) configured to perform various functions of analysis system 150. Analysis system 150 may include an attribution module 152 configured to analyze event data 164 and attribute interaction events 165 to one or more of impressions 168 and/or other interaction events 165. In some illustrative implementations, attribution module 152 may attribute an interaction event 165 to an impression 168 having a same campaign identifier 169 and device identifier 170 (e.g., browser cookie, device serial number, etc.), and having a timestamp 171 indicating that the impression 168 occurred prior to the interaction event 165. Attribution module 152 may also attribute the interaction event 165 to one or more other impressions 168 provided to a user prior to that impression 168. Thus, in one illustrative implementation, if a click 166 (e.g., a selection of a content item by a user) occurred after four associated impressions 168, attribution module 152 may attribute the click 166 to the four impressions 168.

In some implementations, analysis system 150 may include a cross-campaign attribution module 154 configured to attribute interaction events 165 to impressions 168 and/or other interaction events 165 across multiple campaigns. Cross-campaign attribution module 154 may identify one or more campaign groupings 184 including multiple content campaigns. Campaign groupings 184 may each be identified according to the individual campaign identifiers 169 of their component campaigns and/or by an aggregate identifier 186 for the grouping. Cross-campaign attribution module 154 may be configured to attribute an interaction event 165 having a first campaign identifier 169 associated with a first campaign to one or more impressions 168, one or more of which may have a second campaign identifier 169 associated with a second campaign. In some implementations, the interaction event 165 may also be attributed to one or more other interaction events 165, such as clicks 166, that may be associated with the same campaign or a different campaign as the interaction event 165. In some implementations, an interaction event 165 associated with one type of media may be attributed to impressions 168 and/or other interaction events 165 associated with other types of media.

In some implementations, analysis system 150 may include a bucketing module 156 configured to assign interaction events 165 to frequency groups 182 and generate reach and frequency data 180. Bucketing module 156 may assign each interaction event 165 being analyzed to at least one of multiple frequency groups 182 based on a number of impressions 168 to which the interaction event 165 is attributed. For instance, a first interaction event 165 attributed to three impressions 168 may be assigned to a first frequency group 182 associated with a frequency of three, and a second interaction event 165 attributed to five impressions 168 may be assigned to a second frequency group 182 associated with a frequency of four or more.

Bucketing module 156 may generate reach and frequency data 180 based on the assignments. Reach and frequency data 180 may include a number of interaction events 165 assigned to each frequency group 182. For instance, reach and frequency data 180 may indicate, for a particular time period, that a frequency group 182 associated with four impressions includes 500 clicks 166 and 75 conversions 167. In some implementations, bucketing module 156 may be configured to generate data for display to a content provider based on reach and frequency data 180, and the content provider may use the data to evaluate the effectiveness of one or more campaigns.

In some implementations, system 150 may include a late event module 158 configured to handle processing of interaction events 165 occurring after a deadline. In some illustrative implementations, system 150 may process events in periodic timeframes, such as using a daily, 24-hour reporting period. An interaction event 165 occurring shortly after a last impression 168 to which the interaction event 165 is attributed (e.g., before a deadline at the end of the reporting period) may be represented within a same normal event data item 174 as the impression 168. In some implementations, some interaction events 165 (e.g., some conversions 167) may occur after the deadline. For instance, some conversions 167 may occur up to thirty days or more after a last impression 168 is provided to a user.

Late event module 158 may handle such interaction events 165 using one or more separate data items. For instance, in some implementations, normal event data items 174 may be defined as having a positive impression count. If a separate normal event data item 174 is used to represent a late interaction event 165, it will cause the impression count to increase above the amount of actual impressions 168 displayed to the user. In some implementations, late event module 158 may use a late event data item 176 that is defined as having an impression count of zero to represent the late interaction event 165. In some implementations, late event module 158 may use a negative event data item 178 configured to cancel an effect of a normal event data item 174 including the last impression 168 and/or one or more other impressions 168 to which the late interaction event 165 is attributed. Late event module 158 may then generate a new normal event data item 174 including the events reflected in the cancelled normal event data item 174 as well as the late interaction event 165. Using either of late event data items 176 or negative event data items 178 may allow system 150 to preserve a periodic reporting structure using normal event data items 174 and still handle late events without causing inaccuracies in the impression counts for those events.

In some implementations, system 150 may include a grouping module 160 configured to generate groupings of campaigns and/or events. In some illustrative implementations, grouping module 160 may generate one or more campaign groupings 184. Each campaign grouping 184 may include two or more campaigns, and the campaigns may be related to a same medium or different media. In some implementations, grouping module 160 may generate campaign groupings 184 based at least in part on user input (e.g., a content provider may select the campaigns to be grouped). In some implementations, grouping module 160 may generate campaign groupings 184 based at least in part on characteristics of the campaigns, such as a content category, bid values/ranges, geographic targets, etc.

In some implementations, grouping module 160 may generate event groupings 188. In some such implementations, event groupings 188 may be generated based on the events belonging to the same campaign grouping 184. In some implementations, event groupings 188 may be generated based on characteristics of the events, such as time characteristics 190 (e.g., a time at which the events occurred) and/or other characteristics 192 (e.g., based on characteristics data 173 of the events, such as a location associated with the events, a subject matter or category of the events, etc.). Some event groupings 188 may be generated based on both a timezone (e.g., indicated by a timezone key 172) and a local time (e.g., indicated by a timestamp 171) of the events, and other event groupings may be generated based on only one of the timezone and the local time.

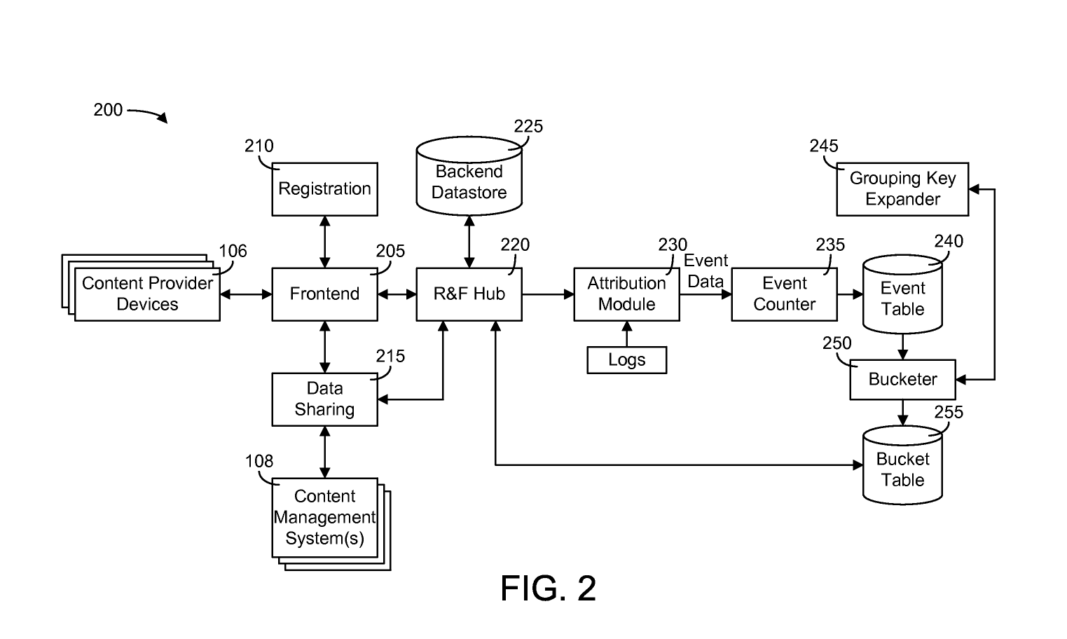

Referring now to FIG. 2, a block diagram of an analysis system 200 is shown according to an illustrative implementation. System 200 is a more detailed implementation of system 150, according to one illustrative implementation. System 200 reach and frequency hub (R&F hub) 220 that operates as a backend coordination module for functions of system 200. R&F hub 220 is configured to communicate with a frontend 205 that provides information to and/or receives input from content provider devices 106. In some implementations, frontend 205 may facilitate a network-accessible interface, such as a web portal, through which content provider devices 106 may communicate with R&F hub 220. Access for new content providers and/or content provider devices 106 may be regulated using a registration module 210, which may authenticate one or more credentials associated with content providers and/or content provider devices 106 and determine whether or not frontend 205 should permit access to each content provider device 106.

In some implementations, system 200 may include a data sharing module 215 configured to communicate with content management systems 108. Data sharing module 215 may receive log information from a content management system 108 indicating data such as impressions presented by content management system 108, clicks made by users after being presented with the impressions, conversion actions completed by users, and/or other types of interaction information. In some implementations, data sharing module 215 may also receive information regarding the content campaigns relating to the interactions, such as campaign identifiers, characteristics of the campaigns and/or content items of the campaigns, etc. Data sharing module 215 may transmit the received information to R&F hub 220, which may store the information in a backend datastore 225.

R&F hub 220 may provide the log data to an attribution module 230 configured to process the log data and generate event data indicative of attributions of events to other events, such as impressions and/or other interaction events. For instance, attribution module 230 may receive log files indicative of a conversion, a click, and three impressions, all of which are associated with the same campaign and device identifiers (e.g., indicating that the events were all related to the same campaign and presented to the same user device 104). In some implementations, attribution module 230 may attribute the conversion to the click and the three impressions that occurred prior to the click. In some implementations, attribution module 230 may additionally or alternatively attribute the click to the three impressions occurring before the click. Attribution module 230 may generate event data configured to provide an indication of the attribution relationship between the events.

The processed event data may be received by an event counter 235 configured to compute event counts based on the event data. In some implementations, event counter 235 may compute event counts over a predetermined timeframe for each device/user identifier. In some implementations, event counter 235 may compute the event counts for each combination of device/user identifier and timezone key, for example, to preserve different timezone keys corresponding to different events (e.g., in different media) pertaining to the same device/user identifier. The processed event counts may be stored in an event table 240.

In some implementations, the timeframe over which event counter 235 counts the events may be relatively long, such as an hour. In such implementations, multiple events may be aggregated together within the same count, which may make it difficult to discern the events for the purpose of assigning events to different frequency buckets in different event groupings. In some implementations, event counter 235 may use a very short timeframe, such as one second, to increase a likelihood that each event will be counted individually and individually reflected in event table 240. In some implementations, event counter 235 may count each event individually and may not aggregate event counts over a timeframe.

In some implementations, system 200 may include a grouping key expander 245 configured to generate various grouping keys based on the characteristics of the events. In some such implementations, grouping key expander 245 may receive the event data and/or characteristic data relating to the events from event counter 235 and/or event table 240. Grouping key expander 245 may analyze the characteristic data of the events and determine one or more characteristics and/or combinations of characteristics relating to the events. For example, different characteristic sets may be identified based on combinations of characteristics such as campaign identifiers, campaign groupings, categories (e.g., sports, home, food, etc.), geographic location (e.g., country, city, county, continent, region, etc.), time data (e.g., timezone, time range, etc.), and/or other types of characteristics. In some implementations, grouping key expander 245 may identify some or all possible combinations of the various characteristics reflected in the event data. Each combination of characteristics may be reflected within a grouping key, and grouping key expander 245 may provide the generated grouping keys to a bucketer 250 for use in assigning events to various frequency buckets for various combinations of characteristics. In some implementations, grouping key expander 245 may allow updates to one or more characteristics, such as campaigns in the groupings. In some implementations, system 200 may update the historical frequency buckets without re-processing the historical logs.

Bucketer 250 is configured to assign events to different frequency groups based on the number of events (e.g., impressions) to which they are attributed. Bucketer 250 may retrieve processed event count data from event table 240, and may compute event counts for the different combinations of characteristics generated by grouping key expander 245. For instance, in one illustrative implementation, bucketer 250 may compute event counts for each of a first grouping key corresponding to a first timezone, a second grouping key corresponding to the first timezone and a first time range, a third grouping key corresponding to the first timezone, first time range, and a first device type, a fourth grouping key corresponding to a second timezone, a fifth grouping key corresponding to the second timezone and a second device type, etc.

In some implementations, for each grouping key, bucketer 250 may generate one or more tables for use in assigning events to frequency groups and determining the number of events associated with each frequency group. For instance, in one illustrative implementation, for each grouping key, bucketer 250 may generate a first table for use in determining a reach for each frequency group (e.g., a number of users presented with impressions a number of times associated with the frequency group), a second table for use in determining a number of clicks attributed to a number of impressions associated with the frequency group, and a third table for use in determining a number of conversions attributed to a number of impressions associated with the frequency group. The entries of event table 240 selected for use in generating each table may be determined based on the entries having characteristics that match the characteristics associated with the grouping key. In some implementations, the tables may be correlated to groups of timeframes (e.g., one row per day), such that bucketer 250 may determine event totals for arbitrary time/date ranges (e.g., arbitrary ranges selected by a content provider). The tables and/or other data (e.g., aggregated event total data) may be stored in a bucket table 255. R&F hub 220 may access the information stored in bucket table 255, for example, for use in reporting the information to a content provider device 106 via frontend 205.

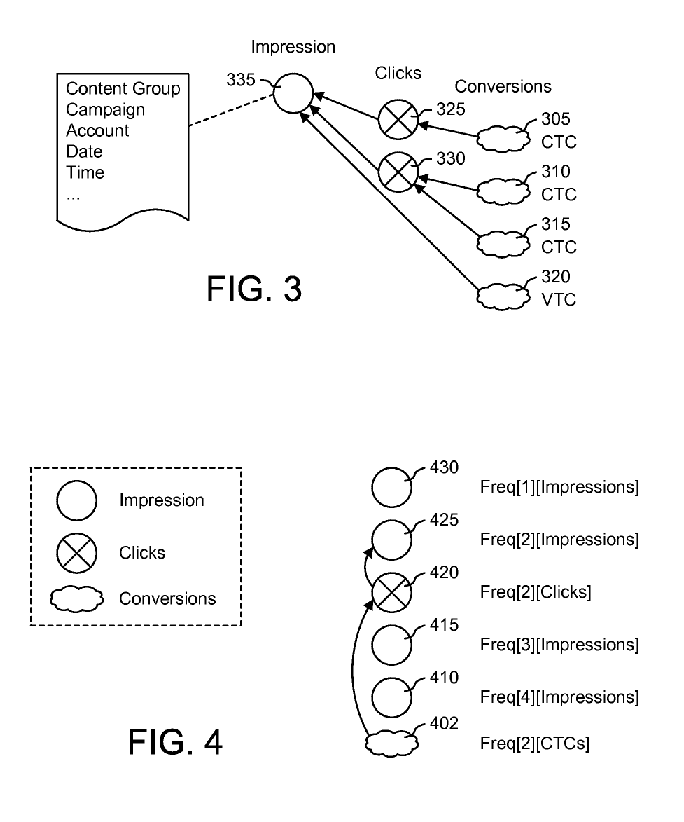

FIG. 3 illustrates click and conversion attribution according to one illustrative implementation. Each event may have associated characteristics, such as content group, campaign, account (e.g., content provider identifier), date, time, etc., which may be stored in or otherwise associated with the event data items. In some implementations, conversions may be attributed to either a click, an impression, or both. When a conversion occurs, the system may look back for clicks and/or impressions to which the conversion should be attributed (e.g., look back a predetermined time period, such as 30 days prior to the conversion). If there is an associated click (e.g., a click having the same account identifier, campaign identifier, and/or device/user identifier), the conversion may be attributed to the last click. The conversion and/or click may in turn be attributed to one or more impressions displayed to the user prior to the click. In some implementations, impressions after the click may be ignored. Such a conversion may be referred to as a click-through conversion, or CTC, because it is attributed to a click. If there is not a click, the conversion may be attributed to a last impression. The conversion and/or last impression may in turn be attributed to zero or more impressions occurring prior to the last impression. Such a conversion may be referred to as a view-through conversion, or VTC, because it is attributed to a view of an impression, rather than a click. If there are no clicks or impressions, in some implementations, the conversion may remain unattributed and may be discarded.

In the illustrated implementation, a first CTC 305 is attributed to a first click 325, which is in turn attributed to an impression 335. In some implementations, first CTC 305 may be attributed to first click 325 and impression 335 because all three may share a common campaign identifier and device/user identifier, indicating that the events all represent interactions with a particular user pertaining to the same campaign. A second CTC 310 and a third CTC 315 may both be attributed to a preceding click 330, which may also be attributed to impression 335. Finally, a VTC 320 may be attributed to impression 335 but not to either of clicks 325 or 330 (e.g., based on characteristics of VTC 320 and clicks 325 and 330).

FIG. 4 is another illustration of click and conversion attribution including frequency values according to an illustrative implementation. A CTC 405 is attributed to a click 420, which is in turn attributed to a last impression 425 and a prior impression 430. In the illustrated implementation, CTC 405 is assigned a frequency value of two, despite the fact that four impressions, including impressions 410 and 415, were displayed prior to CTC 405, because CTC 405 is attributed to the last click 420. In this implementation, because impressions 410 and 415 occur after click 420, they are ignored. In other implementations, impressions 410 and 415 may be counted within the frequency count or otherwise accounted for in determining the frequency value associated with CTC 405.

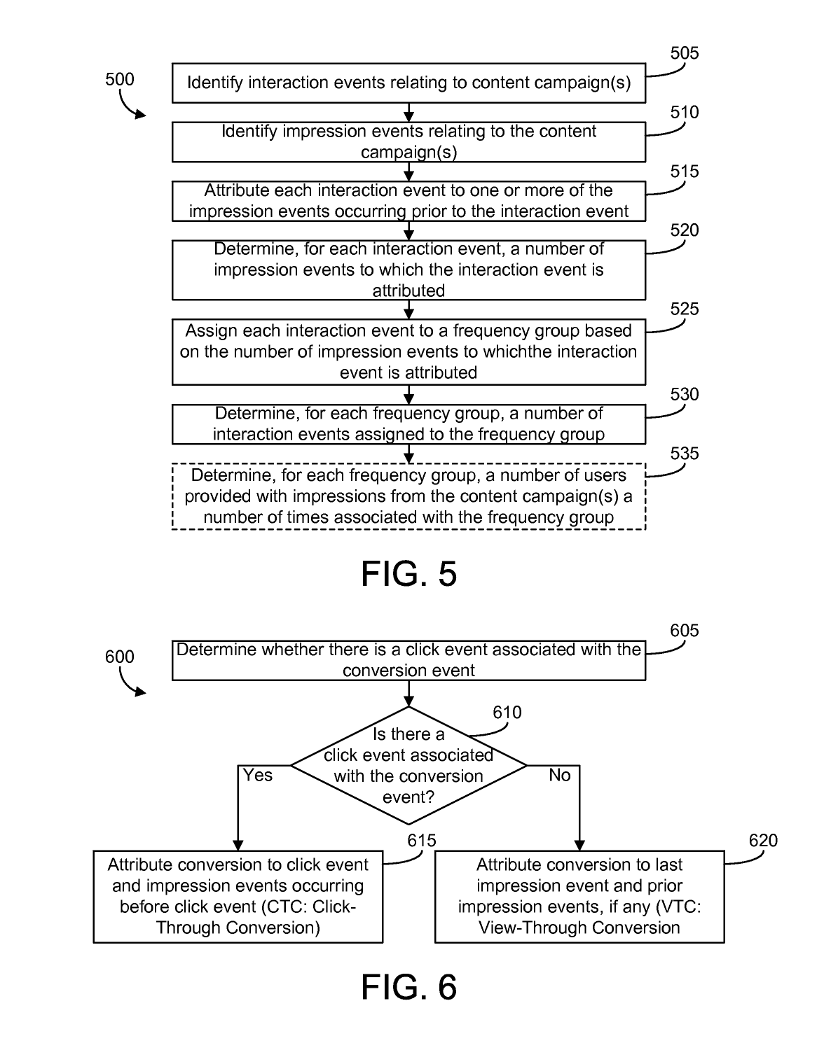

FIG. 5 illustrates a flow diagram of a process 500 for attributing interaction events to impression events and assigning events to frequency groups according to an illustrative implementation. While the discussion of FIG. 5 below (as well as various other figures) makes reference to both FIGS. 1 and 5, it should be understood that the illustrative analysis system 200 shown in FIG. 2 could also be used to perform the operations shown in FIG. 5 and discussed below.

Analysis system 150 may be configured to identify one or more interaction events 165 relating to one or more content campaigns (505). Interaction events 165 may include any type of events representing interaction of a user with content from the content campaign(s). In some implementations, interaction events 165 may include clicks 166 representing selections of content item impressions. In some implementations, interaction events 165 may include conversions 167, such as purchases of products and/or services by users, submission of requested information by users, and/or other types of user actions desired by a content provider. In some implementations, analysis system 150 may identify relevant interaction events 165 within log data based on the interaction events 165 having associated campaign identifiers 169 that match an identifier of a campaign for which analysis is to be performed.

Analysis system 150 may identify one or more impressions 168 relating to the content campaign(s) (510). Each impression 168 may represent an instance of a content item being presented to a user via a user device 104. In some implementations, analysis system 150 may identify relevant impressions 168 based on the impressions 168 having associated campaign identifiers 169 that match an identifier of a campaign for which analysis is to be performed.

In some implementations, interaction events 165 and/or impressions 168 may have associated characteristics that may be used to identify interaction events 165 and/or impressions 168, attribute events to one another, and/or otherwise analyze interaction events 165 and/or impressions 168. For instance, interaction events 165 and/or impressions 168 may have a campaign identifier 169 that identifies one or more campaigns with which the content associated with the interaction events 165 and/or impressions 168 is associated.

In some implementations, interaction events 165 and/or impressions 168 may have a timestamp 171 indicating a time and/or date associated with the event. In some implementations, timestamp 171 may provide a local time associated with the event. In some illustrative implementations, the interaction events 165 and/or impressions 168 to be analyzed may be selected based on a time range associated with the analysis (e.g., a user-selected time range, such as an arbitrary time range). For instance, in some illustrative implementations, the only impressions 168 included in the analysis may be those whose timestamps 171 indicate that they occurred within a particular date and/or time range (e.g., clicks 166 and/or conversions 167 may or may not be included in the date/time range). In some implementations, only clicks 166 and/or conversions 167 occurring within the date/time range may be included in the analysis (e.g., impressions 168 may or may not occur within the date/time range). In some implementations, interaction events 165 and/or impressions 168 may have multiple timestamps 171 (e.g., one that indicates a time at which the event occurred, and one that indicates a time at which the event was logged by a content management system 108, analysis system 150, or another system).

In some implementations, interaction events 165 and/or impressions 168 may have a timezone key 172 that provides an indication of a timezone associated with the event (e.g., U.S. Eastern timezone, British timezone, etc.) In some implementations, timezone key 172 may include an indirect indication of a timezone, such as a content provider identifier that identifies a content provider located in a particular location, or a location identifier providing a location associated with the event. In some implementations, interaction events 165 and/or impressions 168 may have other associated characteristic data 173, such as a location associated with the event, a category of subject matter associated with the event (e.g., category associated with the content item related to the event), etc.

Analysis system 150 may attribute each interaction event 165 to one or more of impressions 168 occurring prior to interaction event 165 (515). Attribution, in this context, may include direct attribution of an interaction event 165 to a first impression 168, as well as indirect attribution of the interaction event 165 to zero or more impressions 168 occurring prior to the first impression 168. In some implementations, the associated interaction events 165 and impressions 168 may be determined based on campaign identifier 169 and timestamp 171 of the events. For instance, in one illustrative implementation, an interaction event having a campaign identifier CampaignID1 and a timestamp indicating the interaction event occurred on Jun. 6, 2014 at 12 PM may be attributed to a first impression having the campaign identifier CampaignID1 and a timestamp of Jun. 6, 2014 at 11:55 AM, but may not be attributed to a second impression having a campaign identifier CampaignID2 (e.g., because the campaign identifiers do not match) or a third impression having a timestamp of Jun. 7, 2014 at 12 PM (e.g., because the impression occurred after the interaction event). In some implementations, system 150 may determine the associated interaction events 165 and impressions 168 based on other criteria. In some implementations, system 150 may determine the associated interaction events 165 and impressions 168 based on timezone key 172. For instance, in one illustrative implementation, an interaction event associated with the U.S. Eastern timezone may be attributed to a first impression associated with the same timezone, but may not be attributed to a second impression associated with the British timezone. In some implementations, system 150 may determine the associated interaction events 165 and impressions 168 based on characteristic data 173 (e.g., a category with which the interaction events 165 and impressions 168 are associated).

In some implementations, analysis system 150 may attribute a click 166 to one or more impressions 168. Analysis system 150 may attribute (e.g., directly attribute) the click 166 to a last impression 168 occurring before the click 166 (e.g., based on timestamp 171 associated with the click 166 and last impression 168) that meets the criteria for attribution (e.g., campaign identifier 169 that matches a campaign identifier 169 for the click 166 and/or campaign identifiers 169 for the campaigns being analyzed, matches characteristics for the analysis, such as geographic criteria, etc.). The click 166 may also be indirectly attributed to zero or more impressions 168 occurring before the last impression 168.

In some implementations, analysis system 150 may attribute a conversion 167 to one or more impressions 168. FIG. 6 illustrates a flow diagram of a process 600 for attributing a conversion 167 to one or more clicks 166 and/or impressions 168 according to an illustrative implementation. System 150 may determine whether there is a click 166 associated with the conversion 167 (605, 610). In some implementations, system 150 may determine whether conversions 167 are associated with clicks 166 and/or impressions 168 in a manner similar to that described above with respect to the attribution of clicks 166.

If there is a click 166 associated with the conversion 167, system 150 may classify the conversion 167 as a click-through conversion (CTC), and may attribute the conversion 167 to the click 166 and one or more impressions 168 occurring before the click 166 (615). In some implementations, system 150 may disregard any impressions 168 provided to the user after the last click 166. In some implementations, system 150 may attribute the CTC to multiple clicks 166 and/or multiple impressions 168.

If there is not a click 166 associated with the conversion 167, system 150 may classify the conversion 167 as a view-through conversion (VTC), and may attribute the conversion 167 to a last impression 168 provided prior to the conversion 167 (620). The VTC may also be attributed (e.g., indirectly) to one or more impressions 168, if any, occurring prior to the last impression 168 prior to the VTC. In some implementations, if there are no impressions 168 associated with the conversion 167, the conversion 168 may remain unclassified and may be discarded.

The process described above with respect to FIG. 6 is provided for purposes of illustration. It should be understood that, in other implementations, conversions may be attributed in other manners. For instance, a conversion may be attributed to any impressions occurring prior to the conversion, regardless of whether they occurred after a last click.

Referring again to FIGS. 1 and 5, system 150 may determine, for each interaction event 165 being analyzed, a number of impression 168 to which the interaction event 165 is attributed (520). System 150 may determine a frequency value for each interaction event 165 based on this determination. For instance, if a CTC is attributed to a click and three impressions prior to the click, the CTC may be determined to have a frequency value of three (e.g., based on the three impressions. System 150 may assign each interaction event 165 to a frequency group 182 based on the number of impressions 168 to which interaction event 165 is attributed (525). For instance, all interaction events 165 attributed to three impressions may be assigned to one frequency group 182, all interaction events 165 attributed to four impressions may be assigned to another frequency group 182, etc.

System 150 may determine, for each frequency group 182, a number of interaction events 165 assigned to the frequency group 182 (530). In some implementations, system 150 may store the event data, including the attribution information, in a format that allows for system 150 to determine event totals for different combinations of criteria/dimensions and/or time ranges. For instance, in some implementations, system 150 may be store the event and attribution data in a format, such as a table or set of tables, that allows system 150 to identify a date and/or time range (e.g., based on input from a content provider) and determine the event totals based on the time range (e.g., based on the impressions 168 and/or interaction events 165 falling within the arbitrary time range provided by the content provider). In some implementations, system 150 may generate reach and frequency data 180 for the different criteria for presentation to a content provider via a content provider device 106. In some implementations, system 150 may determine the event totals for several different types of interaction events, such as clicks, click-through conversions and view-through conversions.

In some implementations, system 150 may additionally or alternatively determine a reach for each frequency group 182, or number of users provided with impressions from the campaign(s) a number of times associated with the frequency group (535). In some such implementations, system 150 may determine, for each of one or more impressions, a number of other impressions to which the impression is attributed. For instance, if an impression occurs after three impressions having a same campaign identifier 169 and device identifier 170, the impression may be assigned to a frequency group associated with four impressions (e.g., the impression and the three prior impressions). For each frequency group, system 150 may determine a number of impressions assigned to the frequency group.

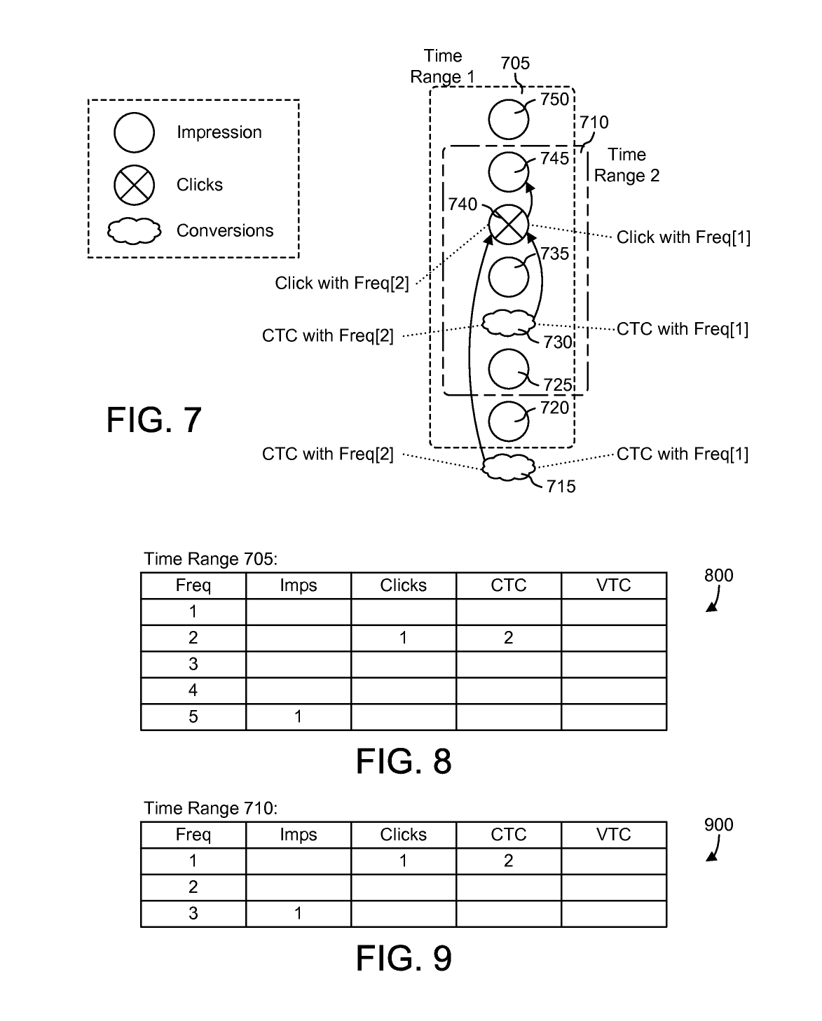

FIG. 7 provides an illustration of click and conversion attribution with different time ranges according to an illustrative implementation. As discussed above, in some implementations, system 150 may be configured to adjust attribution and event total calculations based on a timeframe. In some implementations, system 150 may be configured to determine attribution and event totals based on an arbitrary timeframe, such as a timeframe received from a content provider (e.g., a date and/or time range). In the illustrated implementation, a first time range 705 includes all of several impressions 720, 725, 735, 745, and 750, as well as a conversion 730 and a click 740. A second time range 710 includes only impressions 725, 735, and 745, as well as conversion 730 and click 740.

In the illustrated implementation, for time range 705, system 150 attributes a conversion 715, occurring after both time ranges 705 and 710, to click 740. In turn, both conversion 715 and click 740 are attributed to impression 745. Conversion 715 and click 740 are also attributed to impression 750, as impression 750 is within time range 705. Impression 730 is also attributed to click 740 and impressions 745 and 750. Thus, for time range 705, system 150 identifies a total of two click-through conversions (715 and 730, attributed to click 740) with a frequency of two (attributed to two impressions 745 and 750) and one click (740) with a frequency of two (attributed to two impressions 745 and 750). System 150 also identifies one impression with a frequency of five (impression 720, which is attributed to four prior impressions 725, 735, 745, and 750). These determinations are illustrated in table 800 shown in FIG. 8.

For time range 710, system 150 again attributes conversions 715 and 730 to click 740 and impression 745. However, system 150 does not attribute conversions 715 and 730 or click 740 to impression 750, as impression 750 is outside of time range 710. Thus, for time range 710, system 150 identifies a total of two click-through conversions (715 and 730, attributed to click 740) with a frequency of one (attributed only to impression 745) and one click (740) with a frequency of one (attributed only to impression 745). System 150 also identifies one impression with a frequency of three (impression 725, which is attributed to four prior impressions 735 and 745), as impressions 720 and 750 fall outside of time range 710. These determinations are illustrated in table 900 shown in FIG. 9.

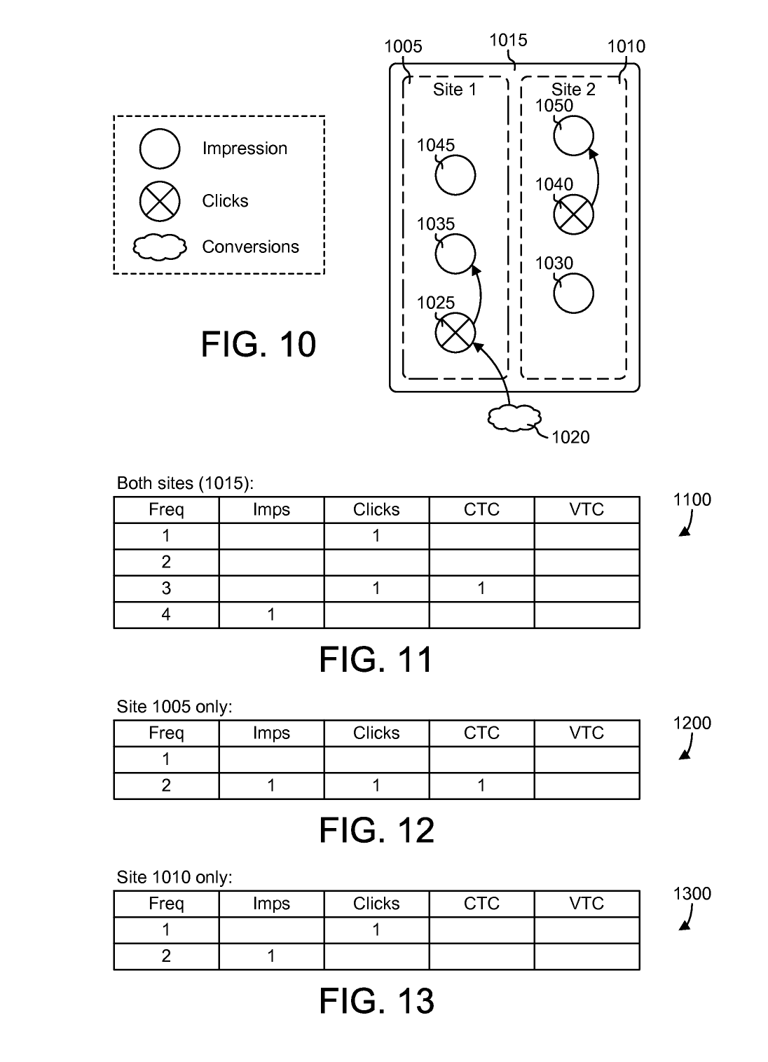

In some implementations, reports may be sliced between multiple sites (e.g., multiple timezones, geographic areas, etc.). FIG. 10 illustrates click and conversion attribution with different sites according to an illustrative implementation. In some implementations, attributions may be a constant input to the pipeline and may not be affected by slicing in different dimensions/criteria, but reporting numbers may be updated to reflect the slicing.

In the illustrated implementation, a first site 1005 includes a click 1025 and two impressions 1035 and 1045. A second site 1010 includes a click 1040 and impressions 1030 and 1050. A combined site 1015 includes both sites 1005 and 1010.

In the illustrated implementation, for the combined site, system 150 attributes a conversion 1020 to click 1025 and impressions 1035, 1045, and 1050. Click 1025 is attributed to impressions 1035, 1045, and 1050. Click 1040 is attributed to impression 1050. Thus, system 150 identifies a click-through conversion (1020, attributed to click 1025) with a frequency of three (attributed to impressions 1035, 1045, and 1050), a click (1025) with a frequency of three (attributed to impressions 1035, 1045, and 1050), and a click (1040) with a frequency of one (attributed to impression 1050). System 150 also identifies one impression with a frequency of four (last impression 1030, attributed to impressions 1035, 1045, and 1050). These attributions are reflected in table 1100 of FIG. 11.

For site 1005 only, system 150 attributes conversion 1020 to click 1025 and impressions 1035 and 1045, but not to impression 1050, as it is outside of site 1005. Click 1025 is also attributed to only impressions 1035 and 1040 for the same reason. Last impression 1035 for site 1005 is attributed to impression 1045. Thus, for site 1005, system 150 identifies one click-through conversion (1020, attributed to click 1025) with a frequency of two (attributed to impressions 1035 and 1045), one click (1025) with a frequency of two (attributed to impressions 1035 and 1045), and one impression (1035) with a frequency of two (attributed to impression 1045). These attributions are reflected in table 1200 of FIG. 12.

For site 1010 only, system 150 attributes click 1040 to impression 1050 and impression 1030 to impression 1050. Conversion 1020 is attributed to click 1025, which is outside of site 1010, and, as a result, conversion 1020 is not included in the reporting for site 1010. Thus, for site 1010, system 150 identifies one click (1040) with a frequency of one (attributed to impression 1050) and one impression (1030) with a frequency of two (attributed to impression 1050). These attributions are reflected in table 1300 of FIG. 13.

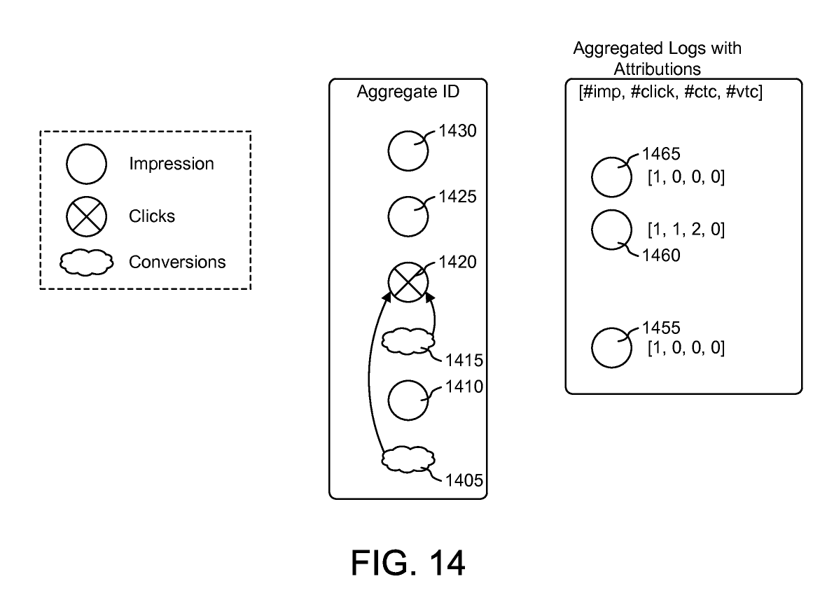

FIG. 14 shows another illustrative click and conversion attribution as well as an illustrative representation of an aggregated log configured to reflect the attribution according to one implementation. In the illustrated implementation, two conversions 1405 and 1415 are each attributed to a click 1420, which is in turn attributed to an impression 1425. In some implementations, conversions 1405 and 1415 and click 1420 may also be attributed to impressions 1430.

Log 1450 is configured to represent each of the illustrated events, including the attributions. In the illustrated implementation, log 1450 includes an entry corresponding to each of three impressions 1410, 1425, and 1430. Each of log entries 1455, 1460, and 1465 may include an indication of a number of clicks, click-through conversions, and view-through conversions directly attributed to the impression (e.g., such that the impression is the last impression provided before the click/conversion). In some implementations, in an event counter table, each impression may be represented by a triple of integers, with separate integers representing a number of clicks, click-through conversions, and view-through conversions directly attributed to the impression.

Log entry 1460, corresponding to impression 1425, reflects an impression count of one (impression 1425), a click count of one (click 1420), and a click-through conversion count of two (conversions 1405 and 1415). Log entries 1465 and 1455, corresponding to impressions 1430 and 1410, respectively, include only impression counts, because no clicks/conversions are directly attributed to impressions 1430 and 1410. In some implementations, log 1450 may include, or have associated therewith, a representation of a time relationship between the impressions (e.g., timestamps for each impression). Based on the time relationship, system 150 may determine that click 1420 and conversions 1405 and 1415 are also attributable to impression 1430, corresponding to log entry 1465, because impression 1430 occurred before impression 1425.

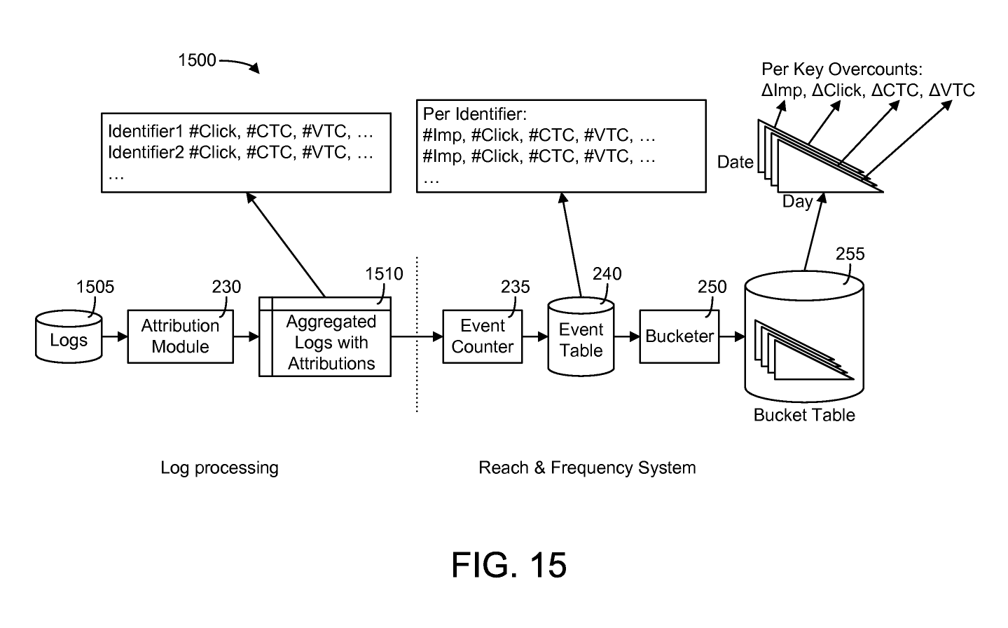

FIG. 15 illustrates a block diagram 1500 of log processing and reach and frequency portions of analysis system 200, shown in FIG. 2, according to an illustrative implementation. FIG. 15 provides an illustrative implementation of how data may be structured in various components of the log processing and reach and frequency portions of system 200.

System 200 may receive log data 1505 representative of one or more types of user interaction events, such as impressions, clicks, and/or conversions, from one or more content management systems 108. In some implementations, each log entry may indicate a campaign identifier and/or device/user identifier associated with the entry, which may allow system 200 to correlate events to determine whether they are associated with a same device/user and/or same campaign or group of campaigns. Attribution module 230 may process log data 1505 to identify impressions and determine events to be attributed to the impressions.

Attribution module 230 may generate a set of aggregated logs 1510 including data entries indicative of attributions of interaction events to impressions. In the illustrated implementation, each log entry in aggregated logs 1510 represents an impression and includes an identifier (e.g., a device/user identifier indicative of a device on which the impression was displayed), as well as a number of clicks, CTCs, and VTCs directly attributed to the impression (e.g., such that the impression was the last impression provided prior to the clicks/CTCs/VTCs). In some implementations, fewer, additional, and/or different types of interaction events may be represented in aggregated logs 1510 and attributed to the impressions.

Aggregated logs 1510 may be processed by event counter 235, which may generate counts of interaction events and/or impressions and store the count data in event table 240. In some implementations, event counter 235 may round timestamps and aggregate count data over a particular time period, such as an hour. In some implementations, event counter 235 may be designed to count and store entries from aggregated logs 1510 on a per-event basis or near-per-event basis. For instance, event counter 235 may aggregate count data using a short time period, such as one second. In such implementations, each event may be reflected separately within event table 240 unless two events occur within the same one second time period. Thus, such an implementation may require fairly minimal coding changes while nearly always, if not always capturing events individually.

In the illustrated implementation, each event count data entry may be stored within event table 240 with reference to an individual device/user identifier (e.g., browser cookie). Each event table 240 entry may include an indication of the identifier, and a number of impressions, clicks, CTCs, and VTCs associated with the identifier. In some implementations, each event may be stored with reference to a timezone key associated with the event. For instance, if aggregated logs 1510 include events for a particular device identifier associated with different timezone keys, the events may be logged separately in event table 240, with a first entry referencing the device identifier and the first timezone key, and a second entry referencing the device identifier and a second timezone key. In some implementations, each event may include two associated timestamps (e.g., an event time when the event occurs or is handed down within the logs, and a report time at which the pipeline becomes “aware” of the event).

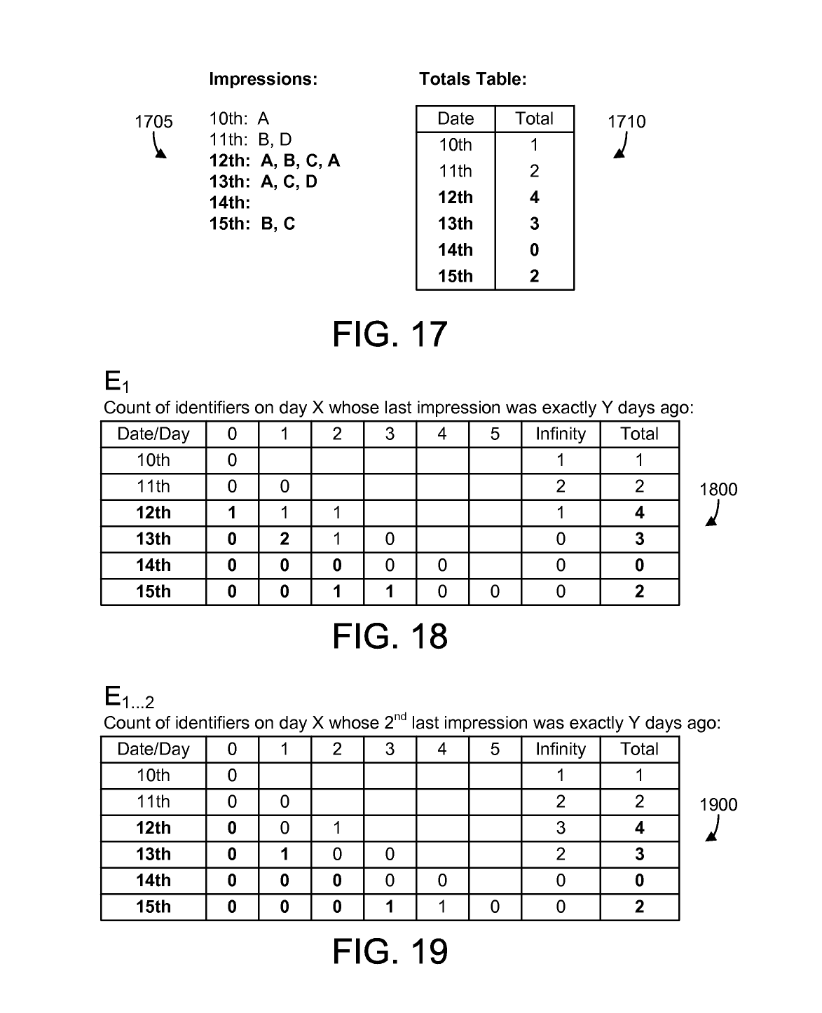

Bucketer 250 may retrieve the data stored in event table 240 and assign the events to frequency groups and determine totals of events within each frequency group. In the illustrated implementation, bucketer 250 generates a series of tables for each grouping key (e.g., each set of characteristics/dimensions to be analyzed). For instance, for each grouping key, a first table may be generated for the impressions associated with the key, a second table may be generated for the clicks, a third table for the CTCs, and a fourth table for the VTCs. In some implementations, the tables may provide a correlation between particular time periods (e.g., dates) and a number of identifiers (e.g., device/user identifiers) whose last impression was a particular time period (e.g., number of days) earlier. Such implementations may allow bucketer 250 to determine event totals for any arbitrary time range (e.g., user-selected time range), for example, as described in further detail below with respect to the illustrative implementations shown in FIGS. 17 through 24.

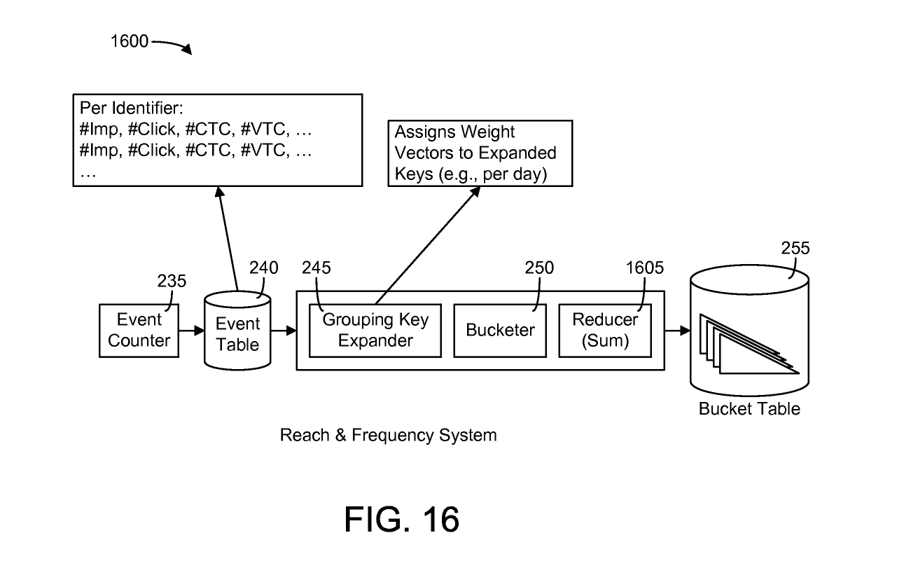

FIG. 16 shows another block diagram 1600 of a reach and frequency portion of analysis system 200 according to an illustrative implementation. Block diagram 1600 illustrates that grouping key expander may assign weight vectors to the expanded keys, with each weight vector including a series of vector parameters corresponding to a set of characteristics/dimensions associated with a key. In some implementations, each weight vector may represent totals for one or more events (e.g., impressions, clicks, conversions, etc.) over a particular time period. In some implementations, the time period may be made short, such as one second, so that each weight vector is likely to represent a single event. The weight vectors may be used by bucketer 250 to generate the tables to be stored in bucket table 255 and used in determining event totals for the different frequency groups. In some implementations, a reducer 1605 may perform the summing/totaling on the tables to determine event totals for the different groups.

FIGS. 17 through 24 show illustrative examples and frequency computation processes for processing events and determining numbers of events associated with each of several frequency groups according to illustrative implementations. In the illustrated implementations, impression and click/conversion data is shown for a time period of a 10th through a 15th day of a month, with queries run over the period R from the 12th through the 15th day.

Referring specifically to FIG. 17, example data including a list of dates upon which impressions are displayed and a table totaling the number of impressions per day are shown according to an illustrative implementation. Impression table 1705 indicates the dates on which impressions from a particular campaign or campaign grouping were shown to users A, B, C, and D. A totals table 1710 indicates the total impressions associated with each of the dates.

FIG. 18 illustrates an overcount table E₁ 1800 showing, for each of the dates illustrated in FIG. 17, a count of device/user identifiers on the date whose last impression was exactly Y days ago (e.g., the same day, one day ago, two days ago, etc.). In some implementations, overcount table E₁ 1800 may be generated by bucketer 250 of FIGS. 2, 15, and 16, based, for example, on event data stored in event table 240. A separate set of overcount tables may be generated for each of multiple grouping keys generated by grouping key expander 245 (e.g., a separate set of overcount tables for each set of characteristics/dimensions). Overcount table E₁ 1800 also includes a column labeled “infinity” noting any last impressions occurring more than five days prior to the dates, as well as a total column noting total last impressions for each date. In overcount table E₁ 1800, the bolded values in the day columns represents overcounts, or counts associated with identifiers that are represented multiple times within the total. The overcount data may help ensure that the totals generated based on the overcount tables are for unique users, and do not overrepresent the number of unique users provided with impressions in each frequency group. In some implementations, overcount tables may be described as triangular tables, as their data is distributed over a substantially triangular pattern, as shown in FIG. 18.

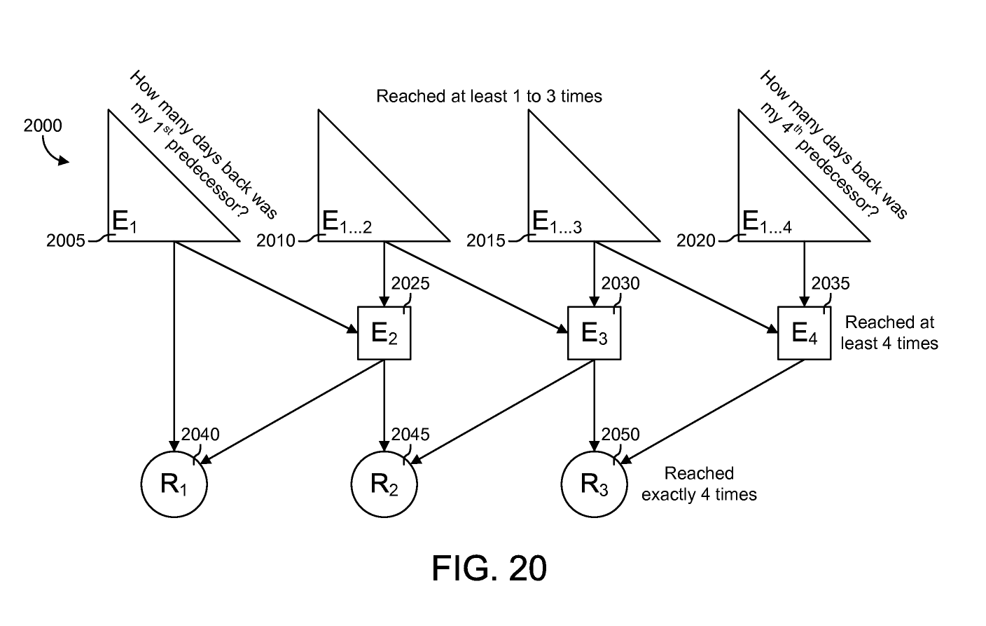

FIG. 19 illustrates an overcount table E_{1..2} 1900 corresponding to the data shown in FIG. 17. Overcount table E_{1..2} 1900 is similar to overcount table E₁ 1800, but illustrates, for each of the dates, a count of device/user identifiers on the date whose second-to-last impression was exactly Y days ago.

FIG. 20 illustrates a data flow diagram 2000 of a process for determining a reach, or unique number of users provided with impressions, for each of several different frequency groups according to an illustrative implementation. Block 2005 represents a set of data indicating, for one or more days, how many days back a first predecessor (e.g., a last impression) was for each identifier (e.g., overcount table E₁ 1800). Block 2010 represents a set of data indicating how many days back a second predecessor (e.g., second-to-last impression) was for each identifier (e.g., overcount table E_{1..2} 1900). Blocks 2015 and 2020 represent similar sets of data for a third predecessor (e.g., third-to-last impression) and fourth predecessor (e.g., fourth-to-last impression), respectively. Totals for each of E₁ and E_{1..2} based on the illustrative tables shown in FIGS. 18 and 19 may be calculated as follows:

E₁: Reached at least 1 time (unique reach)

E₁=Totals_{R1}(4+3+0+2)−Overcount_{R1}(1+2+1+1)=4{A,B,C,D}

E_{1..2}: Reached at least 1 to 2 times

E_{1..2}=Totals_{R1..2}(4+3+0+2)−Overcount_{R1..2}(1+1)=7{A,B,C,D}+{A,B,C}

Blocks 2025, 2030, and 2035 represent a total number of unique users (identifiers) reached at least two times, three times, and four times, respectively. An illustrative calculation of E₂ of block 2025 is presented below:

E₂: Reached at least 2 times

E₂=E_{1..2}−E₁=7−4=3{A,B,C}

E₃ and E₄ of blocks 2030 and 2035 may be calculated in a similar manner, with E₃=E_{1..3}−E_{1..2} and E₄=E_{1..4}−E_{1..3}.

Blocks 2040, 2045, and 2050 represent a total number of unique users (identifiers) reached exactly one time, two times, and three times, respectively. An illustrative calculation of R₁ of clock 2040 is presented below:

R₁: Reached exactly 1 time (frequency 1)

R₁=E₁−E₂=4−3=1{D}

R₂ and R₃ of blocks 2045 and 2050 may be calculated in a similar manner, with R₂=E₂−E₃ and R₃=E₃−E₄.

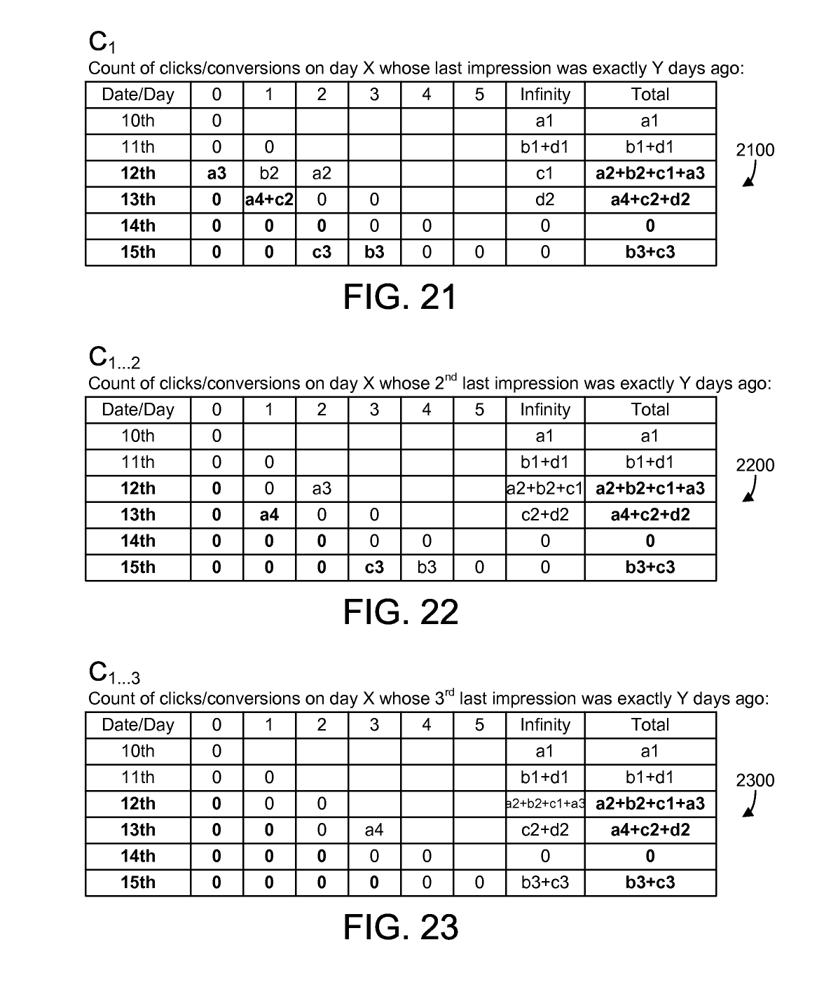

FIGS. 21 through 24 provide example overcount tables and an illustrative process that may be used to determine a number of click events for each frequency group. While the discussion of FIGS. 21 through 24 references clicks, similar tables/processes may be utilized to compute other events, such as conversions. FIGS. 21 through 24 make reference to the illustrative data below, which shows the same list of impressions shown in FIG. 17, but also shows clicks attributed to the impressions:

10th: A (a1)

11th: B (b1), D (d1)

12th: A (a2), B (b2), C (c1), A (a3)

13th: A (a4), C (c2), D (d2)

14th:

15th: B (b3), C (c3)

FIG. 21 illustrates an overcount table C₁ 2100 showing, for each of the dates illustrated above, a count of clicks on the date whose last impression was exactly Y days ago. FIGS. 22 and 23 illustrate overcount tables C_{1..2} 2200 and C_{1..3} 2300 showing counts of clicks whose second-to-last and third-to-last impression, respectively, was exactly Y days ago. Overcounted values are shown in bold in tables 2100 through 2300.

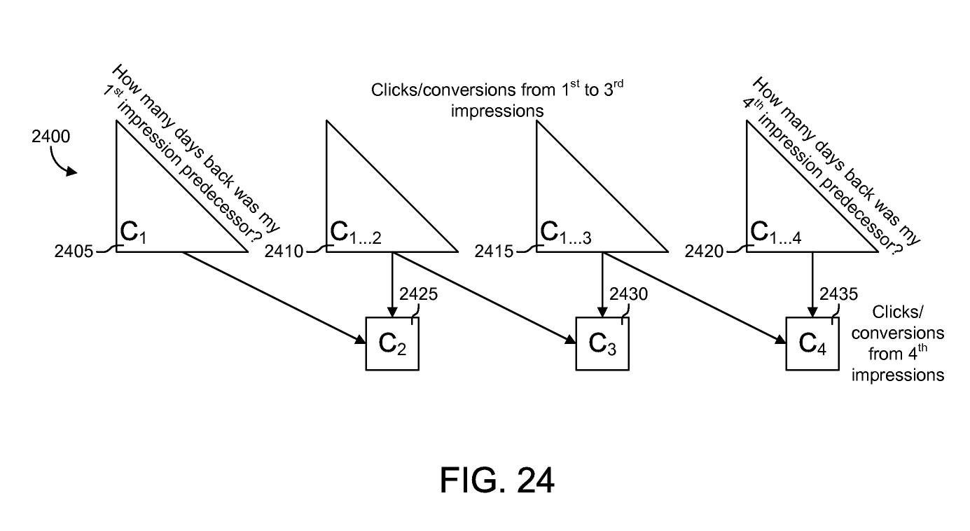

FIG. 24 illustrates a data flow diagram 2400 of a process for determining a total number of events, such as clicks/conversions, for each of several different frequency groups according to an illustrative implementation. Block 2405 represents a total number of clicks that occurred after one impression, block 2410 represents a total number of clicks that occurred after one to two impressions, block 2415 represents a total number of clicks that occurred after one to three impressions, and block 2420 represents a total number of clicks that occurred after one to four impressions. Blocks 2425, 2430, and 2435 represent a total number of clicks that occurred after exactly two, three, and four impressions, respectively. An illustrative calculation of C₁, C_{1..2}, C₂, C_{1..3}, and C₃ is shown below:

C₁: Clicked after 1 impression

C₁=Totals_{R1}−Overcount_{R1}=a2+b2+c1+d2

C_{1..2}: Clicked after 1 to 2 impressions

C_{1..2}=Totals_{R1..2}−Overcount_{R1..2}=a2+b2+c1+d2+c2+a3+b3

C₂: Clicked after 2 impressions

C₂=C_{1..2}−C₁=c2+a3+b3

C_{1..3}: Clicked after 1 to 3 impressions

C_{1..3}=Totals_{R1..3}−Overcount_{R1..3}=a2+b2+c1+a3+a4+c2+d2+b3+c3

C₃: Clicked after 3 impressions

C₃=C_{1..3}−C_{1..2}=a4+c3

Similar calculations may be used to determine C₄.

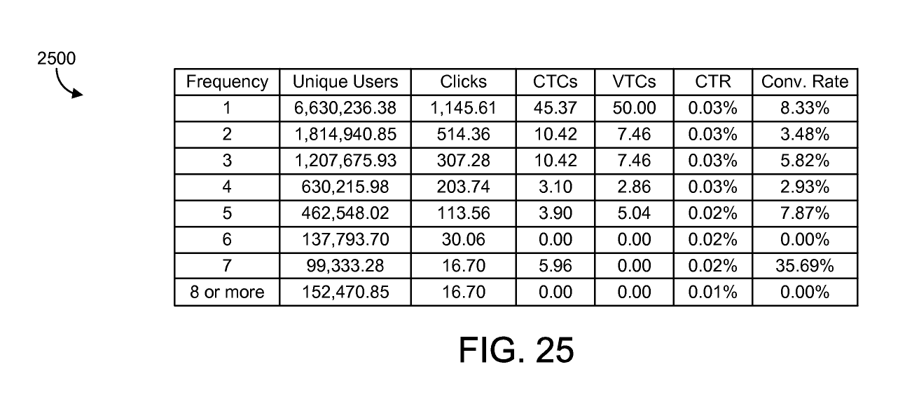

FIG. 25 shows an illustrative user interface 2500 that may be presented, for example, to a content provider according to an illustrative implementation. Interface 2500 includes information for each of eight different frequency groups. The information includes a number of unique users presented with impressions, the number of times associated with the frequency groups. The information also includes a number of clicks, click-through conversions, and view-through conversions that occurred after users viewed a number of impressions associated with the frequency groups. Interface 2500 also shows a click-through rate for each group (e.g., a number of users presented with the impressions who clicked through an impression) and a conversion rate for each group (e.g., a number of users presented with the impressions who performed a converting activity, such as making a purchase). In various other implementations, other types of information may be determined for each frequency group and displayed in an interface such as interface 2500.

In some implementations, system 150 may be configured to aggregate events and impressions to which they are attributed within a same data item when they occur within a particular time period. For instance, system 150 may utilize a single data item to aggregate all impressions and attributed clicks, click-through conversions, and view-through conversions that occur within a particular 24 hour time period. However, in some cases, events, such as click-through and/or view-through conversions, may occur well after the impressions and/or clicks to which they are attributed (e.g., up to thirty days or more after the clicks/impressions). In some implementations, the normal event data items may be defined as having a positive impression count. Thus, if separate normal data items are used to represent the late conversions, the separate items will cause the count of impressions to be inaccurate (e.g., the data item for the late conversion will include an extra impression that did not actually occur).

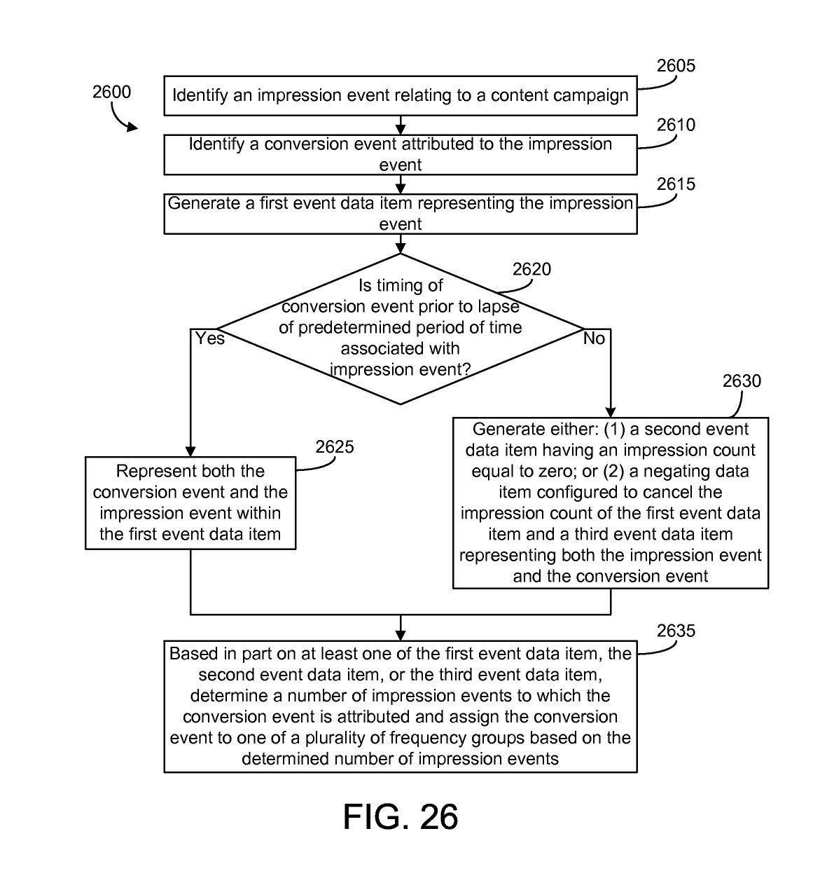

FIG. 26 is a flow diagram of a process 2600 for attributing conversion events to impression events and assigning the conversion events to frequency groups when one or more of the conversion events occur after a deadline according to an illustrative implementation. In some implementations, some of the operations of process 2600 may be implemented using features and/or techniques such as those described above.

System 150 may identify an impression event relating to a content campaign (2605). System 150 may also identify a conversion event relating to the content campaign (2610). The conversion event may be attributed to the impression event.

System 150 may generate a first event data item representing impression event (2615). In some implementations, all related impressions, or all related impressions occurring within a particular time period, may be represented within the same data item. In some implementations, impressions and/or other related (e.g., attributed) event items may be aggregated over a reporting period, such as a daily reporting period. In some implementations, some or all impressions (e.g., the last impression) may be represented within separate data items. In some implementations, the data items in which the impressions are represented may be “normal” data items defined as having a positive impression count greater than zero.

System 150 may determine whether a timing associated with the conversion event is prior to a lapse of a predetermined period of time associated with the impression event (2620). The predetermined period of time may be a reporting period (e.g., 24 hour period) in which a time associated with the impression event falls, a threshold amount of time after the impression event, or some other period of time. In some implementations, system 150 may make this determination by inspecting a timestamp associated with the conversion event. If the timestamp indicates a time within a same reporting period, for example, system 150 may classify the conversion events as an on-time conversion occurring within the same reporting period as the impression event. If not, system 150 may classify the conversion event as a late-occurring event occurring in a later reporting period.

If the timing of the conversion event is prior to the lapse of the predetermined period of time, system 150 may represent the conversion event within the first event data item with the impression event (2625). The data item used to represent the first conversion event and impression event(s) may be a normal data item with a positive impression count and a count of zero or more other events (e.g., clicks and/or conversions).

If the timing of the conversion event is after the lapse of the predetermined period of time, system 150 may generate at least one separate event data item to represent the conversion event (2630). The first event data item used to represent the impression(s) to which the conversion event is attributed may be normal data item having a positive impression count. If system 150 used a separate normal event item with a positive impression count to represent the conversion event occurring after the predetermined period of time, this would cause the impression count to rise above the actual amount of impressions displayed to the user, to which the conversion event was attributed. As a result, the conversion event may be assigned to the incorrect frequency group (e.g., frequency group 5 instead of 4).

In some implementations, system 150 may address this problem using a separate type of data item to accurately log the conversion event without causing an inaccuracy in the impression count. In some such implementations, system 150 may record the second conversion event using a pseudo-event data item that has an impression count of zero and, accordingly, does not have an impact on impressions. In some implementations, the pseudo-event data item may also have a click count of zero to avoid impacting the click count. Such an event data item may be represented as PseudoEvent(0,0,ctc_delta,vtc_delta), where the zeroes represent the counts for the impressions and clicks, and the ctc_delta and vtc_delta represent counts for the late-occurring CTCs and VTCs, respectively. In some implementations, the time assigned to the pseudo-event may be the time of the last impression to which the conversion is attributed.

In some implementations, system 150 may use a combination of a normal event and a negating event to accurately log the conversion event. In such an implementation, the negative event may have a negative count corresponding to parameters (e.g., impressions, clicks, and/or prior conversions) of the first event data item reflecting the impression event. The count of parameters from the older, negated first event data item may be added to the count of late-occurring impressions within a new, normal data item having a positive impression count. The negating event may be represented as NegatingEvent(imp,click,ctc_old,vtc_old), wherein imp, click, ctc_old, and vtc_old are the number of impressions, clicks, CTCs, and VTCs, respectively, reflected in the original normal data item. The new normal event may be represented as Event(imp,click,ctc_new,vtc_new), where imp and click are the impressions and clicks negated from the original normal data item and restored within the new normal data item, and ctc_new and vtc_new are a sum of the CTCs/VTCs, if any, reflected in the original normal data item and the late-occurring CTCs/VTCs.

System 150 may determine a number of impression events to which the conversion event is attributed and assign the conversion event to one of a plurality of frequency groups based on the determined number of impression events (2635). The number of impression events may be determined based on the first event data item (e.g., when the conversion timing is prior to the lapse of the predetermined period of time), the second event data item (e.g., when the conversion timing is after the lapse of the predetermined period of time and a pseudo-event is used to represent the conversion event), and/or the third event data item (e.g., when the conversion timing is after the lapse of the predetermined period of time and a negating event and normal event are used to represent the conversion event).

In some implementations, system 150 may be configured to perform attribution and determine event totals associated with various frequency groups across campaign groupings of two or more campaigns. In some such implementations, the campaigns that form the campaign grouping may be campaigns within a same medium, such as two search-based campaigns. For instance, a first search-based campaign relating to an electronic device may be grouped with a second search-based campaign relating to software for use with the electronic device. In some implementations, the campaigns of the grouping may be campaigns within different media. For instance, the first campaign in the grouping may be a search-based campaign relating to the electronic device, and the second campaign may be a video-based campaign relating to the electronic device. Analyzing a campaign individually may not account for the effect interactions with respect to other campaigns may have on the likelihood of a particular event occurring with respect to the campaign. By considering the campaigns together within a grouping, system 150 may provide a better indication of how the combination of interactions affects the likelihood particular events occurring, such as conversions and/or clicks.

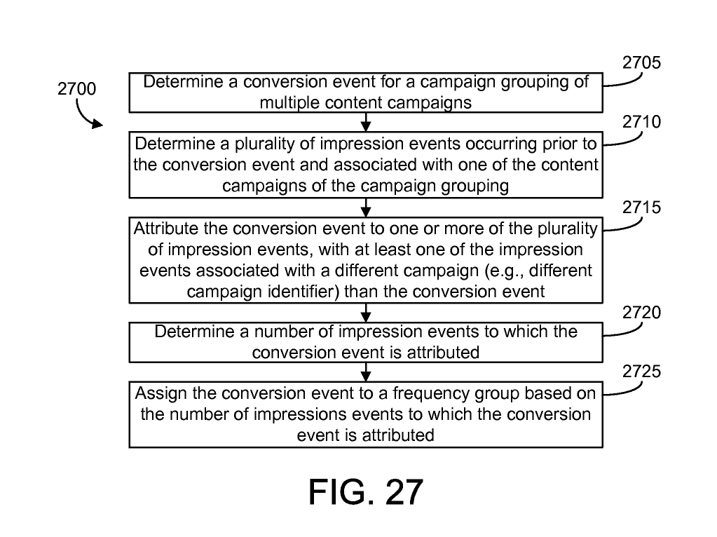

FIG. 27 illustrates a flow diagram of a process 2700 for attributing interaction events (e.g., conversion events) to impression events across a campaign grouping including multiple campaigns according to an illustrative implementation. In some implementations, some of the operations of process 2700 may be implemented using features and/or techniques such as those described above.

Analysis system 150 may determine a conversion event for a campaign grouping of multiple content campaigns (2705). Each content campaign may include one or more content items to be displayed to users via a content medium, such as a search results interface, a video interface, a mapping interface, etc. The campaign grouping may include two or more campaigns associated with a same medium or different media. Analysis system 150 may also determine two or more impression events occurring prior to the conversion event and associated with one of the campaigns in the campaign grouping (2710). In some implementations, analysis system 150 may determine the conversion event and/or impression events associated with the campaign grouping based on individual account/campaign identifiers associated with the campaigns in the grouping. For instance, each conversion and/or impression event having a campaign identifier that matches a campaign identifier of a campaign in the grouping may be identified as being associated with the grouping. In some implementations, the grouping may be assigned an aggregate identifier configured to identify the grouping. For instance, if a particular campaign is involved in three groupings, it may be assigned three aggregate identifiers, one for each grouping. In some implementations, the log entries for a campaign may be tagged with or otherwise associated with the aggregate identifiers for the groupings associated with the campaign.

System 150 may attribute the conversion event to one or more of the impression events (2715). In some implementations and/or for some conversion events, at least one of the impression events may be associated with a different campaign (e.g., different campaign identifier) than the conversion event. In some such implementations, events from individual campaigns may be reattributed as if they belong to one larger, combined campaign. For instance, in one illustrative implementation, if a conversion with respect to a first campaign follows two impressions from the first campaign and two impressions from a grouped second campaign, the conversion may be attributed to all four impressions, and may be assigned to a frequency group of four.

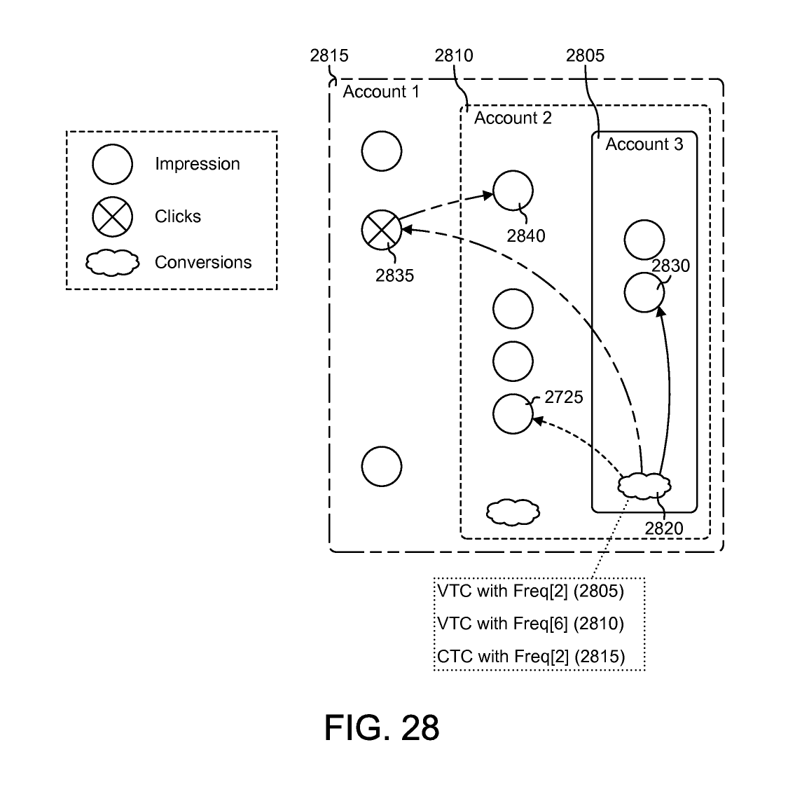

FIG. 28 is an illustration of conversion attribution for multiple campaign groupings according to an illustrative implementation. A first group 2805 includes only an Account 3 (e.g., representing a content campaign or campaign account) associated with two impressions and a conversion 2820. In this group, conversion 2820 is attributed to impression 2830, and is classified as a view-through conversion with a frequency of two, due to impression 2830 and the preceding impression in the Account 3 data.

A second group 2810 includes both Account 3 and a second account, Account 2. Under this grouping, conversion 2820 is again classified as a view-through conversion, as there is no preceding click. However, conversion 2820 is now directly attributed to impression 2825 of Account 2, which is a later impression than impression 2830. Conversion 2820 is determined to have a frequency of six, due to impression 2830 and the five preceding impressions in Accounts 2 and 3.

A third group 2815 includes Accounts 2 and 3 and also includes another account, Account 1. Under this grouping, conversion 2820 is now attributed to click 2835 from Account 1, and is classified as a click-through conversion. Conversion 2820 is assigned a frequency of two, as one impression 2840 in Account 2 and another impression in Account 1 precede click 2835.

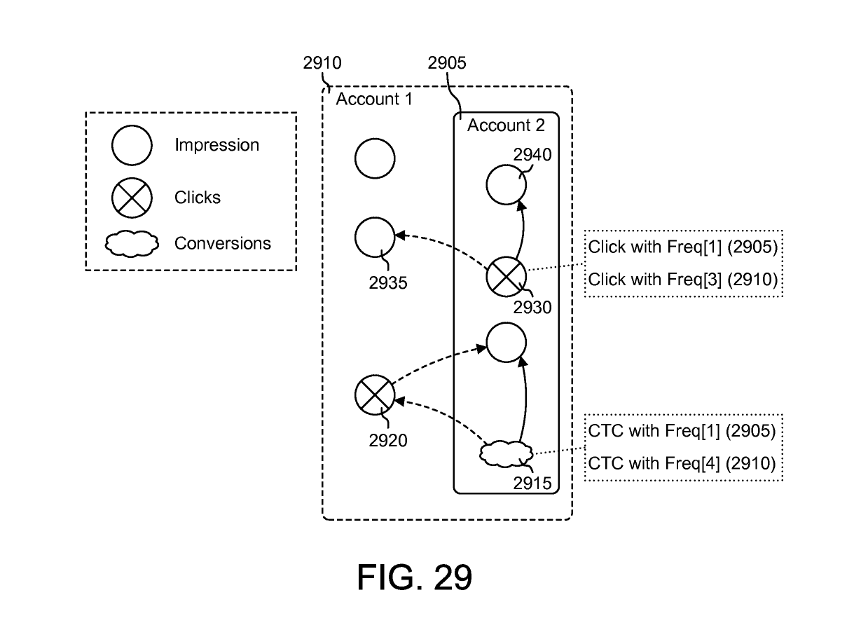

FIG. 29 is another illustration of conversion attribution for multiple campaign groupings according to an illustrative implementation. A first group 2905 includes an Account 2 with a conversion 2915, a click 2930, and two impressions 2925 and 2940. Under this grouping, conversion 2915 is attributed to click 2930, which is in turn attributed to preceding impression 2940. In this illustrative implementation, conversion 2915 is classified as a click-through conversion with a frequency of one. Click 2930 is assigned a frequency of one, as it is attributed only to impression 2940.

A second group 2910 includes Account 2 as well as another account, Account 1. Account 1 includes a click 2920 and two impressions. In this grouping, conversion 2915 is attributed to click 2920, which precedes click 2930. Four impressions within the group precede click 2920, so conversion 2915 is classified as a click-through conversion with a frequency of four. Three impressions precede click 2930 within the group, so click 2930 is assigned a frequency of three.

Referring again to FIG. 27, system 150 may determine a number of impression events to which the conversion event is attributed across the campaign grouping (2720). Based on the number of impression events to which the conversion event is attributed, analysis system may assign the conversion event to a frequency group (2725). The process above may be repeated for several conversions to correctly attribute the conversions across campaign groupings and assign then to correct frequency groups. In some implementations, the steps above may be taken to attribute and assign other types of events, such as clicks and/or impressions (e.g., to determine a reach for different frequency groups across the campaign groupings). In some implementations, a number of events (e.g., conversion events) associated with each frequency group, and/or reach for each frequency group (e.g., a number of users provided with impressions from the campaign grouping a number of times associated with the frequency group), may be determined.

In some implementations, events (e.g., conversions) may be duplicated across different campaigns and/or media, and system 150 may be configured to identify and remove duplicate events. For instance, in some implementations, system 150 may identify duplicate events based on timestamp data, alone or in combination with other characteristics of the events. In one illustrative implementation, system 150 may identify multiple impressions having timestamp data indicating that the events occurred on or near the same time (e.g., within a threshold time range), and having characteristics (e.g., campaign identifier, device/user identifier, etc.) that match one another, and system 150 may determine that the events are duplicates. In some such implementations, system 150 may remove the duplicates such that only one instance of the event is stored in the event data.

In some implementations, groupings may be created, modified, and/or activated/deactivated. For instance, a content provider may initially define three groupings: (1) Group 1, including campaigns A and B; (2) Group 2, including campaigns A and C, and (3) Group 3, including campaigns C and D. The content provider may decide that it is no longer interested in monitoring a grouping of campaigns A and B, and may instead wish to monitor a grouping of campaigns B and C. The content provider may modify Group 1 to include campaigns B and C, instead of campaigns A and B. However, as shown above, correct attributions are dependent upon the campaign grouping. If analysis system 150 implements the change by taking the existing data for the previously defined Group 1 (campaigns A and B) and adds to it with new data, or adds together historical data for the individual campaigns B and C, the attributions will not be correct, and the resultant frequency group data will be inaccurate. A similar issue might result if the content provider chooses to create a new grouping, or if the content provider deactivates a grouping (e.g., such that system 150 is not performing attributions/frequency group assignments for the grouping) and then later reactivates the grouping.

In some implementations, system 150 may utilize a backfill process to ensure that events for new/modified/reactivated groupings are properly attributed and historical data is processed, such that reported frequency group totals are accurate. In some such implementations, system 150 may utilize different pipelines to process groupings that have remained the same since a last reporting period, and groupings that have been newly created, modified, and/or activated. This may help generate reach and frequency data that is deduplicated, or avoids incorrectly counting events and/or impressions multiple times within the reach and frequency data.

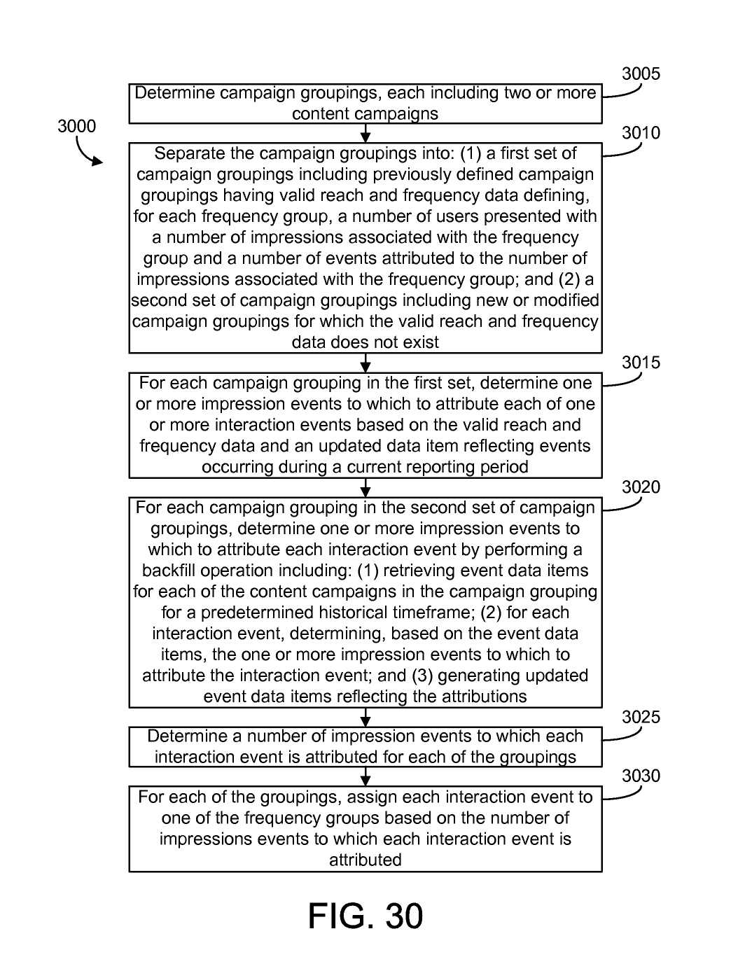

FIG. 30 is a flow diagram of a process 3000 for attributing interaction events to impression events for different campaign groupings using a backfill operation according to an illustrative implementation. In some implementations, some of the operations of process 3000 may be implemented using features and/or techniques such as those described above.

Analysis system 150 may determine two or more campaign groupings, each including two or more content campaigns (3005). In some implementations, analysis system 150 may determine the campaign groupings based on input from a content provider. For instance, system 150 may provide the content provider with an interface (e.g., via a frontend module) through which the content provider may select campaigns to be grouped together for the purpose of generating reach and/or frequency data. In some implementations, system 150 may additionally or alternatively determine campaigns based on characteristics of the campaigns. For instance, system 150 may suggest and/or generate groupings of campaigns that share similar characteristics, such as campaigns directed to the same or similar product/service categories, price categories, geographic regions, etc.

System 150 may separate the campaign groupings into two sets of groupings (3010). The first set of groupings may include previously defined campaign groupings for which a set of valid reach and frequency data (e.g., an up-to-date set of reach and frequency data) has previously been processed. The valid reach and frequency data may define, for each of several frequency groups, a number of users presented with a number of impressions associated with the frequency group and a number of events attributed to the number of impressions associated with the frequency group. The second set of groupings may include new or modified groupings (e.g., groupings where one or more campaigns to be included in the grouping have been changed, or groupings that were deactivated and reactivated) for which valid reach and frequency data does not exist. For instance, reach and frequency data for the second set of groupings may never have been processed (e.g., for a new or modified grouping), or prior reach and frequency data may have been processed but may not be current (e.g., for a reactivated grouping).

For each of the campaign groupings, system 150 may attribute an interaction event (e.g., a click/conversion) to one or more impression events. For each grouping in the first set of groupings, system 150 may determine impression events to which to attribute the interaction event based on the valid first set of reach and frequency data (3015). For instance, system 150 may perform an update operation for groupings that are previously defined and unmodified, such as a periodic update (e.g., daily update). System 150 may utilize the previously processed reach and frequency data, and may update the data based on daily event information received for the grouping.

For each grouping in the second set of groupings, system 150 may determine impression events to which to attribute the interaction event by performing a backfill operation (3020). Using the backfill operation, system 150 may analyze historical data relating to the interaction event and impression events and determine attributions based on the historical data. System 150 may retrieve event data items for each of the campaigns in the grouping for a predetermined historical timeframe. In some implementations, the timeframe may be received from a user (e.g., the past week). In some implementations, the event data items may be retrieved, for example, from log files stored in a backend datastore. Each impression event to be analyzed reflected in the historical data may be attributed to one or more impression events in a manner similar to the cross-campaign attribution described above (e.g., with respect to FIGS. 27 through 29). System 150 may then generate updated event data items reflecting the attributions. The updated event data items may be stored, for instance, in an event table, as described above.

In some implementations, system 150 may determine whether a campaign grouping scheduled to undergo a backfill operation is already in the process of a previous backfill operation. If so, in some implementations, the current backfill operation may be discarded in favor of the new backfill operation, so that the data eventually reported to the content provider is based on the currently selected groupings. A new backfill operation may be performed to generate data for the new/modified grouping.

In some implementations, system 150 may identify an overlap in impressions provided to the same user in two or more of the content campaigns for a campaign grouping. In such implementations, system 150 may modify the reporting data to count the user only once when determining a reach, or unique number of users presented with impressions, for the campaign grouping.

For each of the campaign groupings, system 150 may determine a number of impression events to which the interaction event is attributed (3025), and may assign the interaction event to a frequency group based on the determined number of impressions (3030). In some implementations, multiple interaction events may be attributed and assigned for one or more of the campaign groupings.

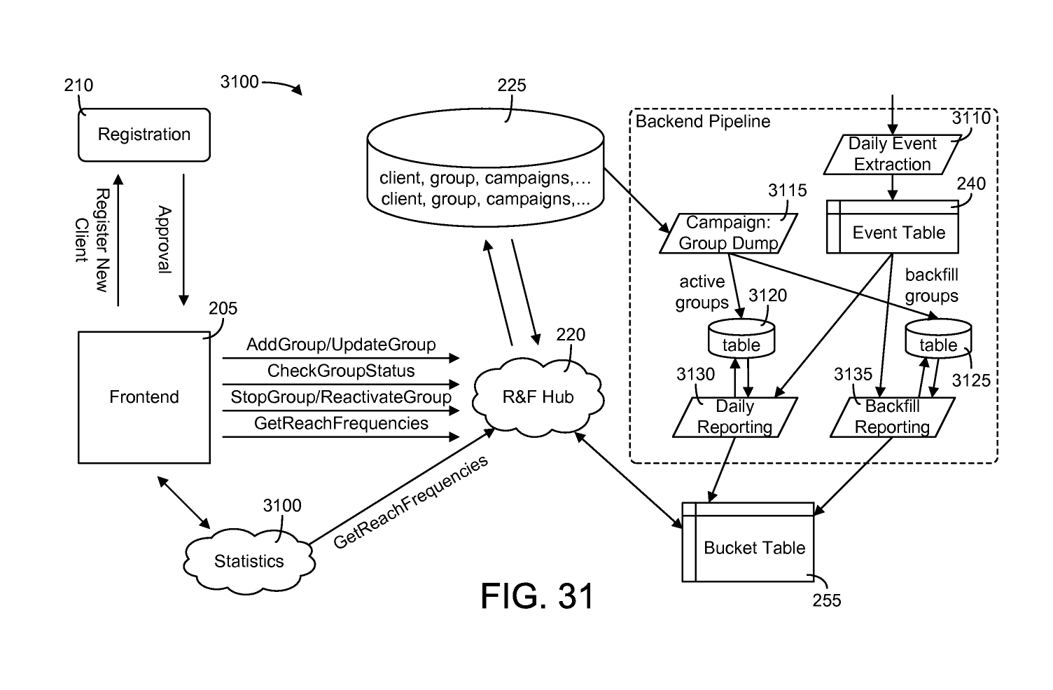

FIG. 31 is a block diagram 3100 of a backend pipeline for processing attribution for campaign groupings according to an illustrative implementation. FIG. 31 makes reference to several components shown in FIG. 2 and other figures, and may utilize various features and/or techniques described above.

In the illustrated implementation, frontend 205 may receive one or more commands and/or data from a content provider device. The commands may include an AddGroup command to generate a new grouping of campaigns. In some implementations, the AddGroup command may include as parameters a group identifier (e.g., a content provider-created identifier used to identify the group, such as an aggregate identifier) and/or the campaign identifiers for the campaigns to be included in the grouping. In some implementations, the command may include a client identifier (e.g., an identifier associated with the content provider). The commands may include a CheckGroupStatus command to inquire about the status of a group/report, in response to which a current status may be returned (e.g., ready, currently in backfill, etc.). The commands may include an UpdateGroup command to implement a change to an existing grouping. The commands may also include a StopGroup and/or ReactivateGroup command configured to stop and reactivate reporting for a particular grouping. The commands may also include a GetReachFrequencies command to request retrieval of reach and frequency report data for one or more of the groupings. In some implementations, the statistical report data may be returned through a statistics module 3100 configured to place the data in a format for use by frontend 205 to report the data to a content provider device. Frontend 205 may transmit the commands to R&F Hub 220 for processing.

In the illustrated implementation, the backend reporting pipeline includes two main stages: event extraction and bucket counting. Campaigns may be associated with group identifiers in the bucket counting stage. This may help allow dynamic bundling of campaigns without re-extracting events and duplicating data in storage. When a group is modified or newly created, in some implementations, only the association in the bucket counting stage is redone.

In the illustrated implementation, two separate bucketing processes are running in the backend. A daily reporting module 3130 pulls out new events and produces updated reports for active identifiers each day (e.g., continuously). A backfill reporting module 3135 deletes the reports for modified group identifiers in bucket table 255 and regenerates all reports for the modified group identifiers. In some implementations, both daily reporting module 3130 and backfill reporting module 3135 run on a periodic basis (e.g., daily). If backfill reporting module 3135 does not finish in one day, it may overrun until done, and then start again. In some implementations, in one run, it processes all groups that need backfill. In one illustrative implementation, for each bucket counting job, the following parameters may be specified: (1) timezone keys—list of timezone identifiers (e.g., customer identifiers, associated with the corresponding customer/content provider for the campaigns); (2) time interval—start time; and (3) time interval—end time. The time interval may span the current day. For a backfill job, the time interval may span the date range to be backfilled. Daily event data may be retrieved by a daily event extraction module 3110 and stored in event table 240.

In some implementations, for each timezone key, the mapper of the bucketer may perform zero or two reads of event table 240. First, the mapper may read events specified by the start time and end time of the time interval. This may be used toward device/user identifier counting. Then, if this read is not zero, the mapper may read all of the events for the timezone key to provide a historical timeline for order counting and device/user identifier correction.

A campaign group dump module 3115 (e.g., run in parallel with event extraction) may pull out data dumps from backend datastore 225 for the active groups and the backfill groups. The data dumps may include campaign identifiers mapped to group identifiers and/or client identifiers, and may be loaded in the bucket counting stage for online lookup. In some implementations, campaign group dump module 3115 may also dump the list of customer identifiers for daily reporting and backfill reporting, as well as the backfill start date. The backfill start date may be determined by the earliest date of the group to be backfilled. This may be implemented as either an online or offline process. In some implementations, the data may be stored within local tables 3120 and 3125 of daily reporting module 3130 and backfill reporting module 3135, respectively.

In some illustrative implementations, for any group, there may be two possible status indications in backend datastore 225: (1) ACTIVE—the group is currently active in the backend; or (2) STOPPED—the group is pended/terminated by the client (previous reports may still be available). For each report for the group, there may also be two possible status indications: (1) BACKFILL—report is for a newly created or modified group that requires a backfilling report starting from an earlier date (no reports currently available); or (2) READY—the report is ready for the group. When the group is added, modified, or reactivated through the backend API, the group status may be set to ACTIVE, and the report status may be set to BACKFILL by default. Campaign group dump module 3115 may scan through all of the groups and determine the start date for each BACKFILL group. All the ACTIVE& READY groups may be processed by daily reporting module 3130, and ACTIVE&BACKFILL groups may be processed by backfill reporting module 3135. In some implementations, once each job finishes, the validation job, which verifies the results and performs some sanity checks, may update the report status of the corresponding groups to READY.

The backend may provide a service for clients (e.g., content providers) to retrieve reports directly from bucket table 255, for example, using any dimensional/characteristic combination and/or any arbitrary date/time range. If the status of the report is READY, the service may indicate that previous reports are available for the group, and the client can get the report from the service.

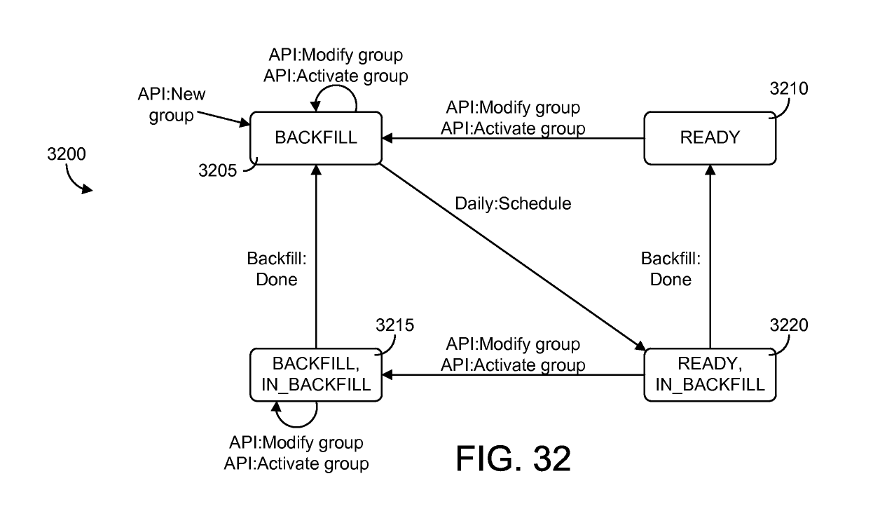

FIG. 32 is a state diagram 3200 illustrating another set of state indications that may be utilized by a system such as that shown in FIG. 31 according to an illustrative implementation. In some implementations, if the backfill process runs for a long time, it could stall the entire pipeline, causing it to miss runs of the daily job. Additionally, in some implementations, if a group is modified while it is being backfilled, the finished backfill process will still mark is as READY, and daily jobs will start computing data for a different definition of the group from what is being backfilled. In some implementations, the first issue may be addressed by having the daily job run for all active groups, and the backfill job run only up to the day before the daily job.

State diagram 3200 illustrates a set of state indications designed to address both concerns. Diagram 3200 introduces a new independent flag, IN_BACKFILL, indicating that a group is now scheduled to be part of a backfill run. The backfill stages may be separated into an independent, continuously running process (e.g., backfill stages of clean data, backfill data, reset IN_BACKFILL status). In some implementations, the daily and backfill processes may be synchronized via a timestamped input file to the backfill. In some implementations, a four valued enum may be used to represent the states instead of a separate flag. By using a separate flag, the API does not need to be aware of the IN_BACKFILL flag, and the backfill process does not need to be aware of the BACKFILL/READY state, so allowing them to be set independently may decrease the complexity of the corresponding code. In some implementations, the two flags may be placed into two separate table columns, possibly in-memory, to allow faster independent getting and setting of the flags.

In the illustrated implementation, state diagram 3200 includes four states: (1) BACKFILL (3205)—modified group; (2) READY (3210)—unmodified group (e.g., any previously requested modifications have been implemented); (3) READY, IN_BACKFILL (3220)—no new modifications requested, but group is currently scheduled to undergo backfill process to address previously requested modification; and (4) BACKFILL, IN_BACKFILL (3215)—group is current scheduled to undergo backfill to address previously requested modification, and subsequent modification has been received.

In the illustrated implementation, the API only changes a group's BACKFILL status, and does so from any state. In some implementations, each new update from the API may happen at a new timestamp.

The daily job may update the groups it schedules for backfill to IN_BACKFILL and change it to the READY (unmodified) state. There is a race condition here in that modification should not be allowed to happen between noticing a group being in BACKFILL and writing the new state, as that would overwrite the modification flag. If the daily job updates the READY/BACKFILL state at the same timestamp as it read it from, no transaction may be needed.

In some implementations, the backfill job (e.g., running independently) may pick up the latest scheduling file for each run. If one version is missed due to a particularly long run, a later file may be a superset of any missed file. Once the backfill is done, the backfill job may update the IN_BACKFILL state of the groups processed. In some implementations, this operation is independent of the READY/BACKFILL state and is not in a transaction.

In some implementations, the analysis system may generate reach and/or frequency information across different media, and each medium may have its own processing pipeline. In such implementations, the analysis system may be configured to utilize a separate, cross-media pipeline portion to integrate data from the pipelines of the separate media. An integrated report may be provided for cross-media campaigns. In some implementations, the services for the different media may not depend on one another to avoid a single-point failure. As an initial step, the system may de-duplicate reach within a same device/user identifier space. Then, a device/user-identifier-to-unique-user model may be utilized to determine reach associated with unique users across media and platforms.

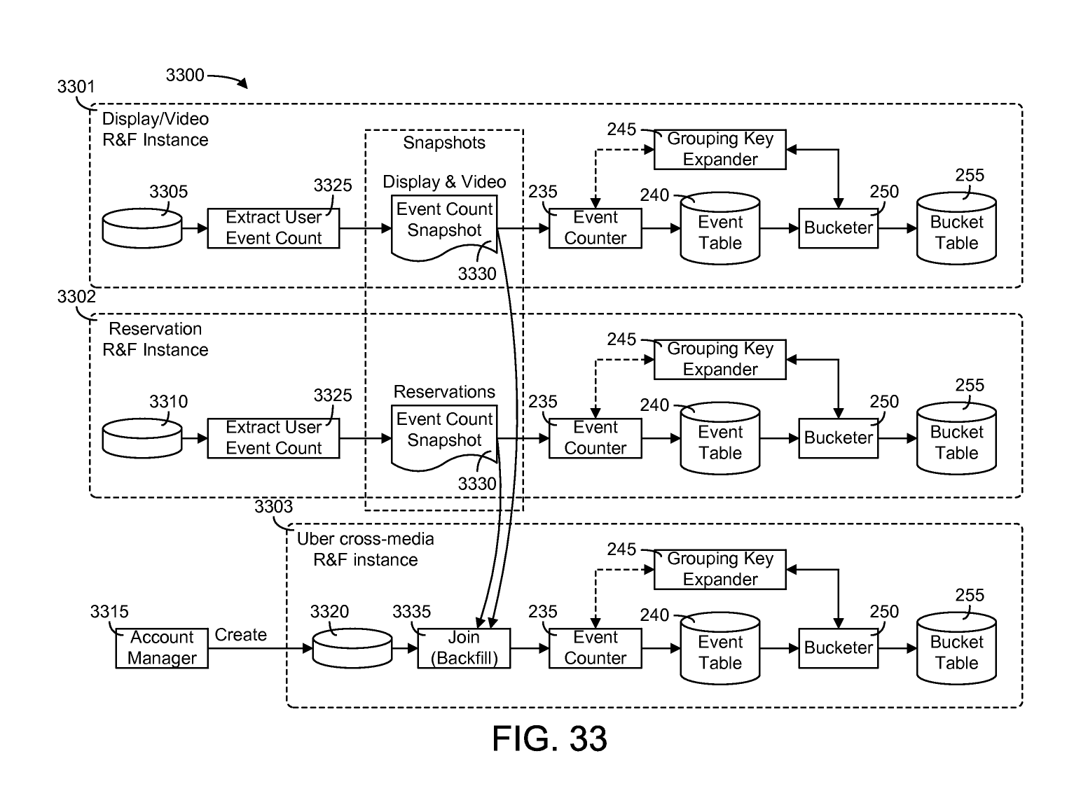

FIGS. 33 through 35 provide different illustrative implementations for processing attribution and frequency grouping across multiple media/platforms. Referring specifically to FIG. 33, a first block diagram 3300 includes a display/video campaign pipeline 3301 associated with processing data for an auction-based medium (e.g., where content items are selected based on an auction process, substantially in real-time), a reservation campaign pipeline 3302 associated with processing data for a reservation-based medium (e.g., where content items are selected for reservation in advance), and a cross-media pipeline 3303. An account manager 3315 may create a campaign grouping including at least one display/video campaign and at least one reservation campaign. An indication of the grouping may be stored in a cross-media log database portion 3320. Log data for display/video pipeline 3301 and reservation pipeline 3302 may be stored in log databases 3305 and 3310, respectively. Event extraction modules 3325 extract event data from databases 3305 and 3310, and event count snapshots 3330 are generated for each pipeline. Event count snapshots 3330 may be transmitted to a backfill module 3335, which may perform a backfill operation using the combined event snapshots to generate reach and frequency data for the grouping.

The illustrative implementation shown in FIG. 33 retains independent pipelines for each of the media, and may avoid complicated integration modifications to those pipelines. The event counter table 240 is regenerated for the cross-media pipeline, which may increase processing and/or storage requirements (e.g., may be a sum of the other instances as coverage grows). One option is to reuse event counter tables of separate instances for the cross-media pipeline. The challenge of joining two different pipelines is the need to join two large event counter tables, because the bucket counting mapper/reducer may expect to read all the events for one device/user identifier as one row from the event table.

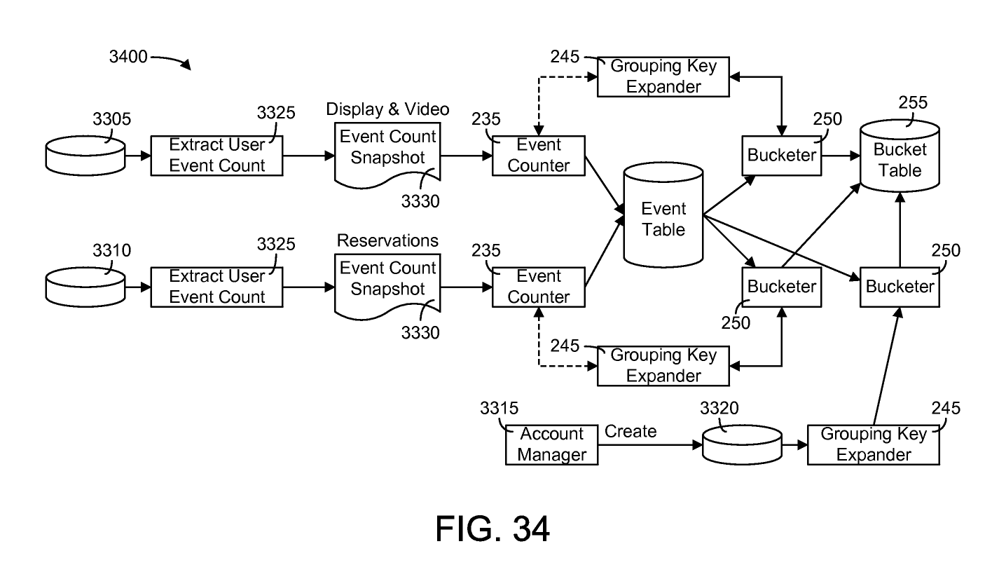

FIG. 34 illustrates a block diagram 3400 of another illustrative implementation. In this implementation, event counter data for both the display/video medium and the reservation medium is written to a same event table 3405. This may allow each pipeline to generate its own report, and also reuse the same code to produce the cross-media report. In some implementations, the schema for event table 3405 may be designed to store event history for each medium in different column families, and an input selected may be added to the bucketers to read from the corresponding column families. In some implementations, the grouping key expanders may be configured to determine aggregate identifiers for the cross-media groupings on the fly for cross-platform/media reporting.

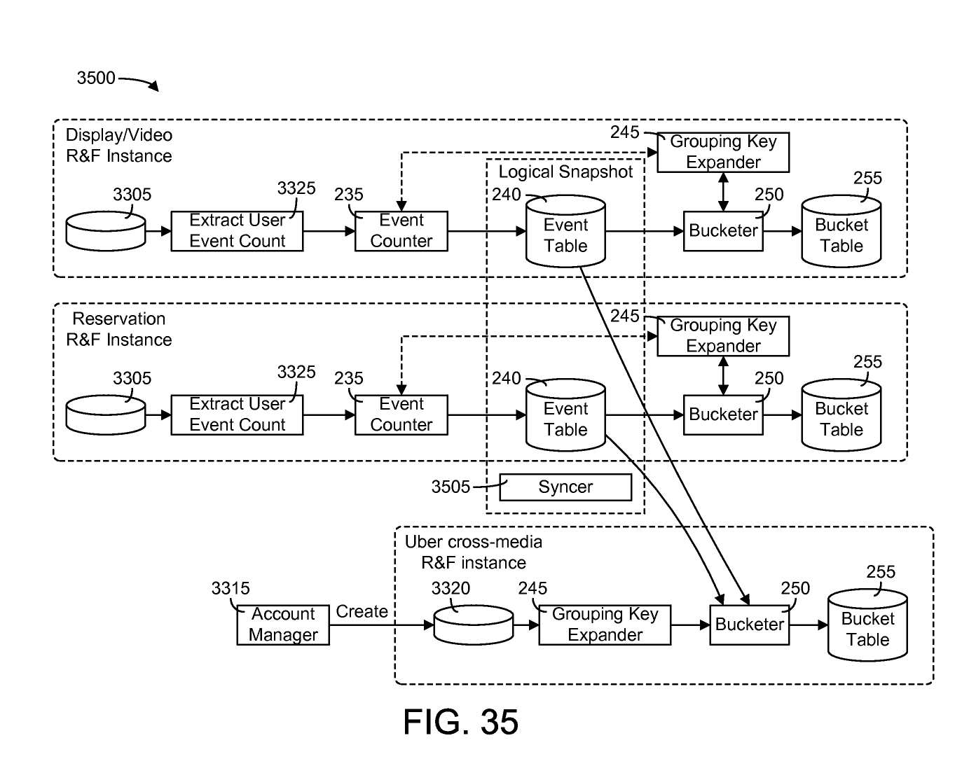

FIG. 35 illustrates a block diagram 3500 of another illustrative implementation. In this implementation, the display/video and reservation media have separate pipelines/instances. For cross-media reporting, a separate bucket table is included that is populated by a bucketer that reads across both the reservation and display/video event counters. In the illustrated implementation, a synchronization module 3505 is provided for synchronizing between pipelines (this may be included in the implementations shown in FIGS. 33 and 34 as well, in some implementations). In the illustrated implementation, each medium has its own specific instance that runs for reporting (e.g., daily). This may help simplify resource and access management that is instance-specific, may avoid integration complications, and may require less changes to the individual pipelines.

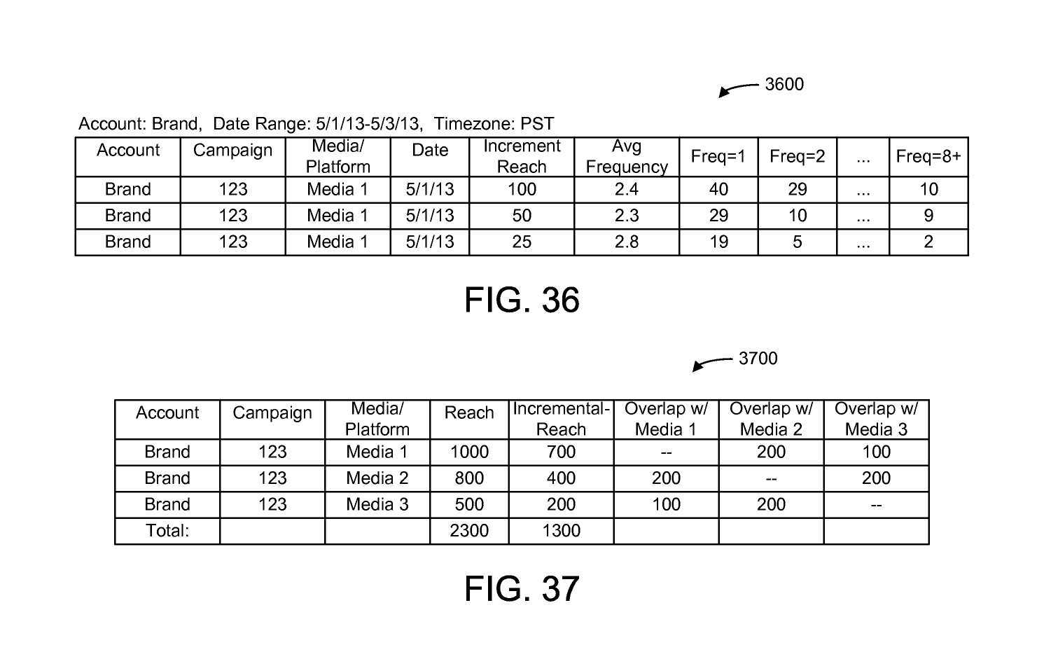

FIG. 36 illustrates a user interface 3600 for providing incremental reach and frequency information according to an illustrative implementation. In the illustrated implementation, data is provided for an account “Brand” and campaign “123” over medium “Media 1” on three separate days. Interface 3600 shows incremental reach associated with each day (e.g., new users reached), and average frequency group associated with the new users reached, and numbers of the users in each frequency group.

FIG. 37 illustrates a user interface for providing cross-media de-duplicated reach and frequency information according to an illustrative implementation. Interface 3700 illustrates information for a campaign that crosses three media. For each medium, interface 3700 shows a total reach (e.g., total unique users reached), an incremental reach (e.g., unique users reached when de-duplicated from overlap with other media), and a number of users overlapping with the other media.

In some implementations, system 150 may be configured to generate different event groupings for a campaign or campaign grouping based on different criteria. For instance, system 150 may generate a first grouping of events for a campaign that occur in the U.S. Eastern timezone, a second grouping of events that occur at 8 PM to 10 PM local time on a Wednesday (e.g., regardless of timezone), and a third grouping of events that occur within an hour before and after a particular event (e.g., a sporting event or television broadcast). In some implementations, system 150 may be configured to determine the events to include in the groupings based on a local time associated with the events, a timezone associated with the events, or both.

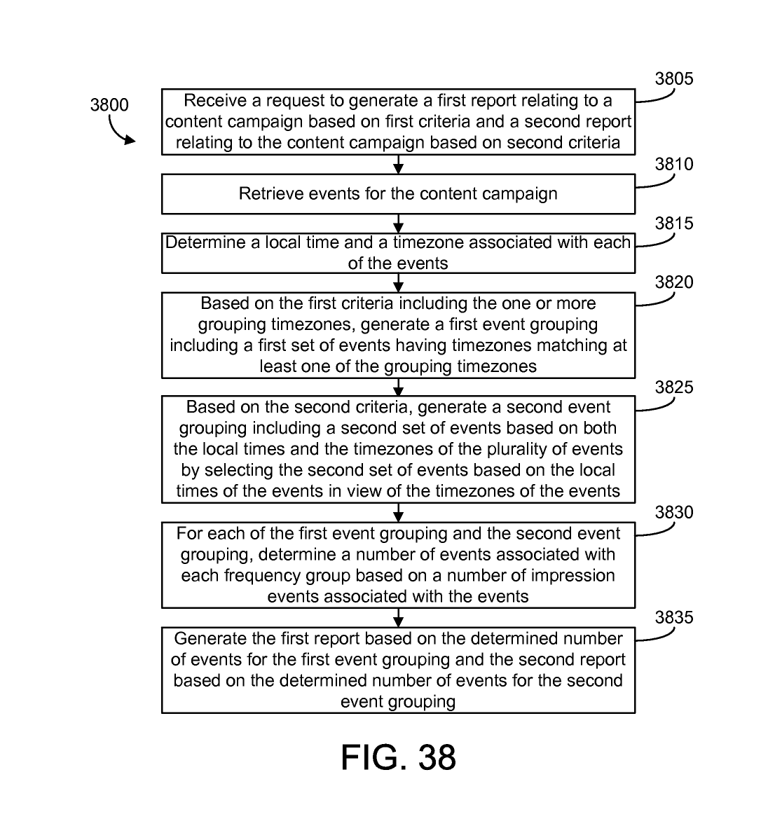

FIG. 38 illustrates a flow diagram of a process 3800 for generating reports for event groupings based on a local time and/or timezone according to an illustrative implementation. FIG. 31 makes reference to several components shown in FIG. 1 and other figures, and may utilize various features and/or techniques described above.

Analysis system 150 may receive a request to generate a first report relating to a content campaign (or campaign grouping) based on first criteria and a second report relating to the content campaign based on second criteria (3805). The criteria may include any of a variety of criteria, such as timezone, time range (e.g., local time), geographic area, time with relation to a particular event or group of events, etc. In some implementations, the criteria may include a time-related component (e.g., specific local time, timezone, start time of an event, etc.). For instance, the criteria may include a particular timezone or group of timezones, a particular local time and/or date range, a time range with respect to one or more events, etc. The first criteria includes one or more specified timezones associated with the first report, and the second criteria does not include a specified timezone for the second grouping.

System 150 may retrieve two or more events associated with the campaign (3810) and determine a local time and timezone associated with each of the events (3815). In some implementations, data representing the events may be stored in log files and/or in an event table/database. In some implementations, each event data item may include or have a reference to at least one timestamp 171 (e.g., including a local time associated with the event) and at least one timezone key 172. Timezone key 172 may indicate a timezone associated with the data. In some implementations, timezone key 172 may directly indicate a timezone, and in others, timezone key 172 may indirectly indicate a timezone (e.g., may include a customer identifier or geographic identifier from which a timezone can be determined, such as based on a location associated with the customer). In some implementations, events associated with a same device/user identifier 170 may have different timezone keys 172 (e.g., events associated with different types of media).

Based on the first criteria including one or more timezones for the grouping, system 150 may generate a first event grouping including a first set of events associated with the timezone for the grouping (3820). In one illustrative implementation, the first criteria may be based on one or more timezones associated with the data. For instance, if the request is for a first report providing data for the U.S. Eastern timezone, system 150 may select events for inclusion in the generated first event grouping when the events have a timezone indicator corresponding to that timezone.

Based on the second criteria that does not include a timezone for the grouping, system 150 may generate a second event grouping including a second set of events based on the timezones associated with the events (3825). System 150 may be configured to retain timezone information on a per-event basis, such that each timezone associated with a particular user/device identifier is preserved and properly accounted for in generating the groupings and reach/frequency data. In one such illustrative implementation, if a particular device identifier is associated with a first event corresponding to a first medium, having a timezone identifier associated with the U.S. Eastern timezone, and a second event corresponding to a second medium, having a timezone identifier associated with the U.S. Central timezone, separate data entries may be stored for each event, and the events may not be aggregated under a single timezone identifier, so that the separate events can be accurately assigned to different groupings (e.g., timezone-specific groupings). For instance, one illustrative grouping may include a first campaign A associated with the U.S. Eastern timezone and a second campaign B associated with the U.S. Pacific timezone. To generate a report including the grouping of campaigns A and B for the date of Jul. 2, 2014, system 150 may include events from campaign A occurring on Jul. 2, 2014 in the U.S. Eastern timezone, and events from campaign B occurring on Jul. 2, 2014 in the U.S. Pacific timezone. In some implementations, system 150 may correlate the local times of the events to a time-related characteristic of the second criteria based on the timezones of the events, and may select the events for inclusion in the second set based on the correlation. In some such implementations, the request may be for a second report including events that occur within a particular time range of a live event, such as a sporting event or a broadcast (e.g., television broadcast). In some such implementations, system 150 may correlate the local time of events with the time associated with the second criteria based on the timezones of the events to determine whether to select events for inclusion in the second set of events. For instance, if the request is for a second report relating to events (e.g., clicks/conversions) occurring within a half-hour on either side of a sporting event occurring from 2-4 PM U.S. Central time, and an event has an associated local time of 8:15 PM and a timezone key indicating the British timezone, system 150 may correlate the local time to the 1:30-4:30 PM U.S. Central timeframe associated with the request criteria based on the British timezone of the event and determine that the timing associated with the event falls within the request criteria timeframe. As a result, system 150 may select the event for inclusion within the second set of events.

In some implementations, system 150 may generate the groupings based on one or more characteristics of the events. The characteristics may include, for example, an event type (e.g., impression, click, conversion, etc.), one or more characteristics of a user and/or device associated with the event (e.g., a device type, such as mobile or desktop), one or more characteristics of the content associated with the event (e.g., content type or category), and/or other characteristics. In some implementations, a content provider user of system 150 may specify the parameters to be used in generating one or more of the groupings.

In some implementations, system 150 may be configured to generate the groupings based on events occurring across multiple media, such as video-based content displayed within a video interface and search-based content displayed within a results interface of a search engine. Systems that log events for different media may be configured to associate events with different timezone indicators and/or timezones. For instance, a system logging events occurring with respect to one medium may log timezones for the events as corresponding to the current timezones based on the location of a user device, a system logging events for a second medium may determine the timezones to correspond to a timezone associated with the registered user address for the account, a system logging events for a third medium may determine the timezones to correspond to a timezone associated with a content provider who provided the content, etc. System 150 may be configured to retain timezone information on a per-event basis, such that each timezone associated with a particular user/device identifier is preserved and properly accounted for in generating the groupings and reach/frequency data.

Once the event groupings are determined, system 150 may determine, for the first event grouping and second event grouping, a number of events associated with each of several frequency groups based on a number of impressions associated with (e.g., attributed to) the events (3830). In some implementations, system 150 may determine a number of impressions to which each event should be attributed and assign the events to the frequency groups based on the number of impressions to which the events are attributed. System 150 may determine total numbers of events associated with each frequency group. System 150 may then generate the first and second reports based on the determined number of events for the first grouping and the second grouping, respectively (3835).

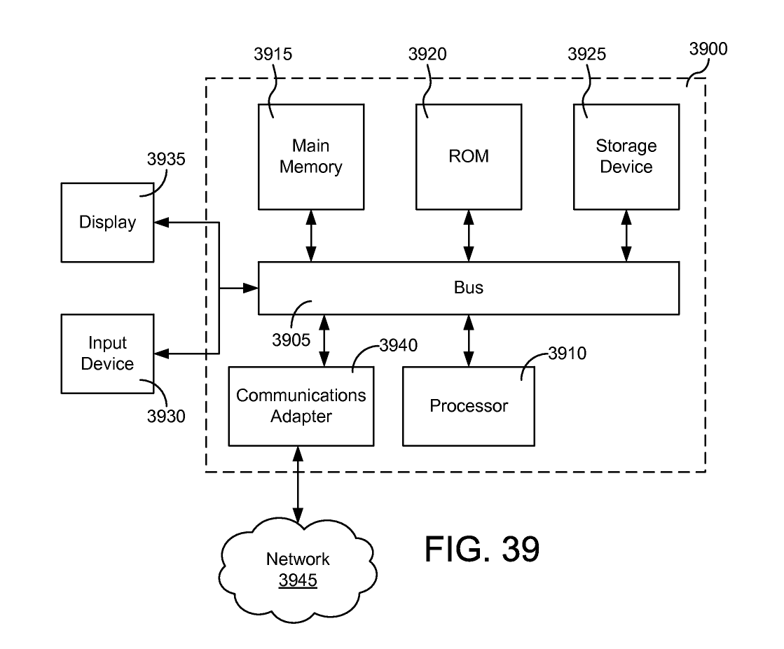

FIG. 39 illustrates a depiction of a computer system 3900 that can be used, for example, to implement an illustrative user device 104, an illustrative content management system 108, an illustrative content provider device 106, an illustrative analysis system 150, and/or various other illustrative systems described in the present disclosure. The computing system 3900 includes a bus 3905 or other communication component for communicating information and a processor 3910 coupled to the bus 3905 for processing information. The computing system 3900 also includes main memory 3915, such as a random access memory (RAM) or other dynamic storage device, coupled to the bus 3905 for storing information, and instructions to be executed by the processor 3910. Main memory 3915 can also be used for storing position information, temporary variables, or other intermediate information during execution of instructions by the processor 3910. The computing system 3900 may further include a read only memory (ROM) 3910 or other static storage device coupled to the bus 3905 for storing static information and instructions for the processor 3910. A storage device 3925, such as a solid state device, magnetic disk or optical disk, is coupled to the bus 3905 for persistently storing information and instructions.

The computing system 3900 may be coupled via the bus 3905 to a display 3935, such as a liquid crystal display, or active matrix display, for displaying information to a user. An input device 3930, such as a keyboard including alphanumeric and other keys, may be coupled to the bus 3905 for communicating information, and command selections to the processor 3910. In another implementation, the input device 3930 has a touch screen display 3935. The input device 3930 can include a cursor control, such as a mouse, a trackball, or cursor direction keys, for communicating direction information and command selections to the processor 3910 and for controlling cursor movement on the display 3935.

In some implementations, the computing system 3900 may include a communications adapter 3940, such as a networking adapter. Communications adapter 3940 may be coupled to bus 3905 and may be configured to enable communications with a computing or communications network 3945 and/or other computing systems. In various illustrative implementations, any type of networking configuration may be achieved using communications adapter 3940, such as wired (e.g., via Ethernet), wireless (e.g., via WiFi, Bluetooth, etc.), pre-configured, ad-hoc, LAN, WAN, etc.

According to various implementations, the processes that effectuate illustrative implementations that are described herein can be achieved by the computing system 3900 in response to the processor 3910 executing an arrangement of instructions contained in main memory 3915. Such instructions can be read into main memory 3915 from another computer-readable medium, such as the storage device 3925. Execution of the arrangement of instructions contained in main memory 3915 causes the computing system 3900 to perform the illustrative processes described herein. One or more processors in a multi-processing arrangement may also be employed to execute the instructions contained in main memory 3915. In alternative implementations, hard-wired circuitry may be used in place of or in combination with software instructions to implement illustrative implementations. Thus, implementations are not limited to any specific combination of hardware circuitry and software.

Although an example processing system has been described in FIG. 39, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (applicationspecific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magnetooptical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including by way of example, semiconductor memory devices, e.g., EPROM, EEPROM, and flash memory devices; magnetic disks, e.g., internal hard disks or removable disks; magnetooptical disks; and CDROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination or in a single implementation. Conversely, various features that are described in the context of a single implementation can also be carried out in multiple implementations, separately, or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, by one or more processors, a request to generate a first report relating to a content campaign based on first criteria and a second report relating to the content campaign based on second criteria, the content campaign comprising a plurality of content items to be provided to a plurality of users, and the first criteria comprising one or more grouping timezones;
retrieving, by one or more processors, a plurality of events for the content campaign;
determining, by the one or more processors, a local time and a timezone associated with each of the plurality of events;
based on the first criteria comprising the one or more grouping timezones, generating, by the one or more processors, a first event grouping including a first set of the plurality of events having timezones matching at least one of the one or more grouping timezones;
based on the second criteria, generating, by the one or more processors, a second event grouping including a second set of the plurality of events based on both the local times and the timezones of the plurality of events, generating the second event grouping comprising selecting the second set of events from among the plurality of events based on the local times of the events in view of the timezones of the events;
for each of the first event grouping and the second event grouping, determining, by the one or more processors, a number of events associated with each of a plurality of frequency groups based on a number of impression events associated with the events; and
generating, by the one or more processors, the first report based on the determined number of events for the first event grouping and the second report based on the determined number of events for the second event grouping.

2. The method of claim 1, wherein the first event grouping is based on a first grouping timezone, and wherein the second event grouping is based on a second grouping time range without a timezone.

3. The method of claim 1, the step of generating the first event grouping comprising generating the first event grouping based on one or more first characteristics of the first set of events, and the step of generating the second event grouping comprising generating the second event grouping based on one or more second characteristics of the second set of events.

4. The method of claim 1, wherein each of the plurality of events is associated with one of a first content medium or a second content medium.

5. The method of claim 4, the step of determining the number of events associated with each of the plurality of frequency groups comprising counting events associated with both the first content medium and the second content medium within the determined number of events.

6. The method of claim 1, wherein each of the plurality of events comprises one of a click event or a conversion event.

7. The method of claim 1, further comprising receiving a selection of one or more parameters for use in determining at least one of the first event grouping or the second event grouping from a content provider.

8. A system comprising:
at least one computing device operably coupled to at least one memory and configured to:
receive a request to generate a first report relating to a content campaign based on first criteria and a second report relating to the content campaign based on second criteria, the content campaign comprising a plurality of content items to be provided to a plurality of users;
retrieve a plurality of events for the content campaign;
determine a local time and a timezone associated with each of the plurality of events;
based on the first criteria, generate a first event grouping including a first set of the plurality of events based on one of the local times or the timezones of the plurality of events;
based on the second criteria, generate a second event grouping including a second set of the plurality of events based on both the local times and the timezones of the plurality of events by selecting the second set of events from among the plurality of events based on the local times of the events in view of the timezones of the events;
for each of the first event grouping and the second event grouping, determine a number of events associated with each of a plurality of frequency groups based on a number of impression events associated with the events; and
generate the first report based on the determined number of events for the first event grouping and the second report based on the determined number of events for the second event grouping.

9. The system of claim 8, wherein the first event grouping is based on a first grouping timezone, and wherein the second event grouping is based on a second grouping time range without a timezone.

10. The system of claim 8, wherein the at least one computing device is configured to generate the first event grouping based on one or more first characteristics of the first set of events, and wherein the at least one computing device is configured to generate the second event grouping based on one or more second characteristics of the second set of events.

11. The system of claim 8, wherein each of the plurality of events is associated with one of a first content medium or a second content medium.

12. The system of claim 11, wherein the at least one computing device is configured to determine the number of events associated with each of the plurality of frequency groups by counting events associated with both the first content medium and the second content medium within the determined number of events.

13. The system of claim 8, wherein each of the plurality of events comprises one of a click event or a conversion event.

14. The system of claim 8, wherein the at least one computing device is further configured to receive a selection of one or more parameters for use in determining at least one of the first event grouping or the second event grouping from a content provider.

15. One or more computer-readable storage media having instructions stored thereon that, when executed by at least one processor, cause the at least one processor to perform operations comprising:
receiving a request to generate a first report relating to a content campaign based on first criteria and a second report relating to the content campaign based on second criteria, the content campaign comprising a plurality of content items to be provided to a plurality of users;
retrieving a plurality of events for the content campaign;
determining a local time and a timezone associated with each of the plurality of events;
based on the first criteria, generating a first event grouping including a first set of the plurality of events based on one of the local times or the timezones of the plurality of events;
based on the second criteria, generating a second event grouping including a second set of the plurality of events based on both the local times and the timezones of the plurality of events, generating the second event grouping comprising selecting the second set of events from among the plurality of events based on the local times of the events in view of the timezones of the events;
for each of the first event grouping and the second event grouping, determining a number of events associated with each of a plurality of frequency groups based on a number of impression events associated with the events; and
generating the first report based on the determined number of events for the first event grouping and the second report based on the determined number of events for the second event grouping.

16. The one or more computer-readable media of claim 15, wherein the first event grouping is based on a first grouping timezone, and wherein the second event grouping is based on a second grouping time range without a timezone.

17. The one or more computer-readable media of claim 15, the step of generating the first event grouping comprising generating the first event grouping based on one or more first characteristics of the first set of events, and the step of generating the second event grouping comprising generating the second event grouping based on one or more second characteristics of the second set of events.

18. The one or more computer-readable media of claim 15, wherein each of the plurality of events is associated with one of a first content medium or a second content medium.

19. The one or more computer-readable media of claim 18, the step of determining the number of events associated with each of the plurality of frequency groups comprising counting events associated with both the first content medium and the second content medium within the determined number of events.

20. The one or more computer-readable media of claim 15, the operations further comprising receiving a selection of one or more parameters for use in determining at least one of the first event grouping or the second event grouping from a content provider.
